(19) United States
(12) Patent Application Publication
(10) Pub. No.: US 2011/0143095 A1
(43) Pub. Date: Jun. 16, 2011

(54) MICROFINE STRUCTURE AND PROCESS FOR PRODUCING SAME

(76) Inventors: Yasuhiko Tada, Tokai (JP); Hiroshi Yoshida, Mito (JP)

(21) Appl. No.: 13/059,751

(22) PCT Filed: Aug. 12, 2009
(86) PCT No.: PCT/JP2009/064217

§ 371 Date: Feb. 18, 2011

(30) Foreign Application Priority Data
Aug. 28, 2008 (JP) 2008-218959

(51) Int. Cl. B32B 3/30; B32B 37/00; B32B 38/10; B32B 3/10

(52) U.S. Cl. 428/156; 156/60; 156/247; 216/36; 428/195.1

(57) ABSTRACT

A process for producing a microfine structure which comprises: a first stage of disposing a polymer layer comprising a block copolymer (103) having at least a first segment (101) and a second segment (102) on a surface of a substrate (105); and a second stage of having the polymer layer undergo microphase separation and form a structure composed of a continuous phase (204) made of the second segments (102) and microdomains (104) which are made of the first segments (101) and are arranged in a penetration direction of the continuous phase (204). The process is characterized in that the substrate (105) has pattern members, each of the pattern members being sparsely disposed at a position where the microdomain (104) is to be formed and different in chemical property from the surface of the substrate (105). The process is further characterized in that the thickness “t” of the polymer layer disposed in the first stage and the intrinsic periodicity “d₀” of the microdomains (104) formed from the block copolymer (103) satisfy the relationship:

(m+0.3)×d₀<t<(m+0.7)×d₀, where m is an integer of 0 or more.

### BACKGROUND OF THE INVENTION

1. Field of the Invention

The present invention relates to a microfine structure comprising extremely small structures created through microphase separation of a block copolymer disposed on a surface of a substrate, and a process for producing the same. Further, the present invention relates to a patterned substrate comprising a regularly arranged pattern of microdomains in the microfine structure on the surface of the substrate, and a process for producing the same.

2. Description of Related Art

Recently, necessity for arranging a fine regular pattern, several to several hundreds nanometers in size, on a substrate has been growing, as an electronic device, an energy storage device, and a sensor or the like are becoming more compact and functional. Accordingly, development of processes capable of producing these extremely fine pattern (or microfine pattern) structures at high accuracy and low cost has been demanded.

A fabrication process for creating a microfine pattern generally includes a top-down method, represented by lithography, in which a bulk material is finely inscribed to have a shape. Photolithography used for finely processing a semiconductor for producing LSIs is one of the representative examples.

However, difficulty in using the top-down method has been increasing from both device and process view points, as the extremely smaller microfine pattern is demanded. Particularly, when a fabrication size of the microfine pattern is extremely small approaching several tens nanometers, the patterning process needs to use an electron beam device or a deep ultraviolet (DUV) device, requiring a huge investment cost for such devices. Further, when formation of a microfine pattern using a mask is difficult, there is no choice but to use a direct writing method, which cannot avoid a problem resulting from a significantly decreased throughput in the fabrication process.

Under the situation as above mentioned, a process using a phenomenon that substances spontaneously assemble a structure in a system, which is called a self-organization phenomenon, has been attracting considerable attention.

Specifically, a process using the self-organization phenomenon of a block copolymer, which is called microphase separation, is an excellent process. That is, in the process, formation of an extremely fine regular structure (or regularly arranged pattern) may be achieved, comprising a variety of shapes with a size of several tens to several hundreds nanometers, by using a simple coating procedure.

It is noted that when different types of polymer segments constituting a block copolymer are not compatible each other (that is, non-compatible), phase separation (or microphase separation) of the polymer segments is caused to undergo self-organization of microstructures having a specific regularity.

For example, conventional techniques are known in which microstructures having a regularity are formed by undergoing the above mentioned self-organization phenomenon. Herein, a structure comprising pores and line-and-space shapes is formed on a substrate by using a film of a block copolymer as an etching mask. The film is comprised of combinations of polystyrene and polybutadiene, polystyrene and polyisoprene, and polystyrene and polymethyl methacrylate.

As mentioned above, the microphase separation phenomenon of the block copolymer allows to obtain a polymer film having a structure in which microdomains with a spherical, cylindrical, or plate microfine shape (lamellar shape) are regularly arranged, while such a structure is difficult to be formed by a top-down method. However, it should be noted that there are the following problems in order to generally apply the self-organization phenomenon including the microphase separation phenomenon to a patterning process.

For example, a polymer film causing microphase separation through self-organization has an excellent property in a short-distance regularity, while such a polymer film has a poor property in a long-distance regularity, including defects therein. Further, it is difficult to form optional patterns in the polymer film. Generally, in a patterning process to which a self-organization phenomenon is applied, a spontaneously formed structure, that is, a structure with the most minimal energy has to be used. Accordingly, this may make it difficult to obtain other structure except for a regular structure having an intrinsic periodicity of a material by the patterning process. The above mentioned restriction of the patterning process causes a problem that the application of the process is limited to a fixed range. In this regard, the following two methods have been developed to solve the problem.

A first conventional method comprises steps of fabricating a groove on a surface of a substrate, and forming a film of a block copolymer inside the groove to thereby undergo microphase separation. According to the method, microstructures produced by the microphase separation are arranged along a wall surface of the groove. Hereby, it is possible to control an array of the regularly arranged structures in a single direction, resulting in improvement of a long-distance regularity. Further, the method may prevent a defect from occurring since the regularly arranged structures are disposed sufficiently along the wall surface of the groove. This effect is known as a graphoepitaxy effect. The effect is decreased associated with increase of a width of the groove, causing disorder of the regularly arranged structures in a center of the groove when the width of the groove is to be about 10 times larger than a periodicity of the regularly arranged structures. Further, this conventional method needs a step of fabricating a groove on a surface of a substrate. Accordingly, it is impossible to apply the method to a process in which a flat surface is needed to be used. Furthermore, in the method, an array of the regularly arranged structures may be disposed in a direction along the groove, while it is impossible to optionally control the patterns except for the above mentioned arrangement.

A second conventional method comprises steps of chemically patterning a surface of a substrate, and undergoing microphase separation through a chemical interaction between the surface of the substrate and a block copolymer. This allows controlling microstructures as described in the U.S. Pat. Nos. 6,746,825 and 6,926,953. (For example, patent documents 1 and 2)

As shown in FIG. 1, in the method, is used a chemically patterned substrate 105, of which surface has been patterned by a top-down method in the regions each having a different affinity to the respective block chains of the high-weight molecular block copolymer. Then, the high-weight molecular block copolymer 103 is deposited on the surface of the chemically patterned substrate 105 to undergo microphase separation. For example, when the high-weight molecular block copolymer 103 composed of polystyrene and polymethyl methacrylate is used, a chemical pattern is formed such that the surface of the substrate is separated into two regions. That is, one region has a good affinity to polystyrene, while the other has a good affinity to polymethyl methacrylate. Herein, when the chemical pattern is made as mentioned above for the microdomains formed by self-organization of a polystyrene-polymethyl methacrylate diblock copolymer, the following microfine structure is obtained during the microphase separation. That is, in the structure, the microdomains formed from polystyrene are arranged on the region having a good affinity to polystyrene, while the microdomains formed from polymethyl methacrylate are arranged on the region having a good affinity to polymethyl methacrylate.

Accordingly, the above described method may make it possible to arrange the microdomains along a mark chemically disposed on the surface of the substrate. The formation of the chemical pattern (or pattern member) by the top-down method may secure the long-distance regularity of the pattern members thus obtained, allowing to obtain the chemical pattern having a good regularity and less defects over a wide region of the surface of the substrate. Hereinafter, the above described method is referred to a chemical registration method of microdomains.

According to the method, it is possible to repair disorder of the shape of the pattern through the top-down method and complement a defect by using the microdomains of the block copolymer. Further, it is reported that the defect may be complemented when the arrangements of the pattern members and the cylindrical microdomains satisfy the relationship of 1:1. Moreover, it is also reported that the defect may also be complemented even when the relationship is n:1 (n is a positive number less than 2) in which the pattern members are arranged insufficiently to the microdomains. Therefore, it is possible to improve a pattern regularity by using the self-organization phenomenon with decreasing a pattern density formed by the top-down method. In other words, it is possible to increase a throughput of the process by decreasing the writing density of the chemical pattern (or pattern members), even if a direct writing method has to be used for forming pattern members in a level of 10 nm size.

### PRIOR ART

### Patent Documents

Patent document 1: U.S. Pat. No. 6,746,825
Patent document 2:U.S. Pat. No. 6,926,953

### SUMMARY OF THE INVENTION

### Problems to be Solved

In the chemical registration method, it is possible to form the chemical pattern (or pattern member) through the top-down method, while defects and disorder of the pattern shape tend to be caused when the chemical pattern (or pattern member) becomes extremely small to several tens nanometers and the density of the chemical pattern (or pattern member) becomes extremely high. This may cause a detrimental effect on the microdomains thus obtained. Therefore, it is preferable to arrange the chemical pattern (or pattern member) disposed sparsely at the position where the microdomain is to be formed, and to form the microdomain by using complementary effect of self-organization, so that the density of the chemical pattern (or pattern member) formed by the top-down method is decreased. However, there is another problem as described below when the arrangements of the chemical pattern (or pattern member) and the cylindrical microdomain have the relationship of n:1 (n is a positive number equal to 2 and more). For example, when a block copolymer deposited on a surface of a substrate undergoes microphase separation, a portion of the surface where the chemical pattern (or pattern member) is formed has a structure in which microdomains are disposed standing upright on the substrate. In contrast, a portion of the surface where the chemical pattern (or pattern member) is not formed has a region where microdomains are not disposed standing upright on the substrate, resulting in failing to obtain a pattern with a high density and complemented chemical pattern. Accordingly, it is difficult to obtain the chemical pattern having less defects without losing along-distance regularity over all regions of the chemical pattern. This problem becomes more significant as a value of n becomes larger.

An object of the present invention is to provide a process for producing a microfine structure including microstructures using the chemical registration method. The process comprises complementing a chemical pattern (or pattern member) disposed sparsely by undergoing a self-organization phenomenon, to thereby produce a phase separated structure having a good long-distance regularity and less defects. More specifically, the present invention provides a process of undergoing self-organization of a block copolymer on a substrate on which a chemical pattern (or pattern member) is formed with a relationship of n:1 (n is a positive number equal to 2 and more) to the microdomain to be formed from the block copolymer, to thereby complement the chemical pattern (or pattern member). Herein, the present invention provides a process for producing cylindrical microdomains which stand upright on the chemical pattern of the substrate. Further, the present invention provides a process for producing a patterned substrate using a polymer film including the microstructures formed by the process as mentioned above.

### Means for Solving the Problem

The process for producing the microfine structure of the present invention is performed as described below in order to solve the above mentioned problems.

The process comprises a first stage of disposing a polymer layer comprising a block copolymer having at least a first segment and a second segment on a surface of a substrate; and a second stage of having the polymer layer undergo microphase separation and form a structure composed of a continuous phase made of the second segment and microdomains which are made of the first segment and are arranged in a thickness direction of the continuous phase.

Here, it is preferable that the block copolymer comprises at least a first segment and a second segment to form cylindrical microdomains or lamellar microdomains through microphase separation.

Further, the surface of the substrate is provided with a first surface which is sparsely disposed on a second surface. Herein, interfacial tension with a first surface of a first material constituting the first segment is smaller than interfacial tension with a first surface of a second material constituting the second segment. Additionally, interfacial tension with a second surface of the second material constituting the second segment is smaller than interfacial tension with a second surface of the first material constituting the first segment.

It is preferable that the scattering arrangement on the first surface is formed to be disposed regularly. Further, a periodicity “d” of the regular arrangement is preferably a multiple of an intrinsic periodicity “d₀” of the microstructures formed through microphase separation of the block copolymer in a bulk state thereof.

Further, in a process for producing a polymer film, the process is characterized in that the thickness “t” of the polymer film satisfies the following relationship to the intrinsic periodicity “d₀” of the microstructures formed through the microphase separation of the block copolymer in the bulk state thereof.

(m+0.3)×d₀<t<(m+0.7)×d₀(m is an integer of 0 or more).

Next, a process for producing the patterned substrate of the present invention will be described hereinafter.

The patterned substrate is produced by the step in which either of the polymer layers formed through the microphase separation is selectively removed from the polymer film produced by the above mentioned process. Then, the other remaining part of the polymer layers is used for fabricating the substrate to transfer the pattern of the microphase separation onto the surface of the substrate, to thereby produce the patterned substrate. Alternatively, the other remaining part of the polymer layers is transferred to produce the patterned substrate. Here, the patterned substrate may be produced by doping the metallic atom to either of the polymer layers produced by the process for producing the polymer film or the patterned substrate as described above.

Note the microfine structure of the present invention refers to the structure in which a polymer film comprising microdomains is formed on the surface of the substrate. Further the patterned substrate of the present invention refers to the substrate in which a regularly arranged pattern of the microdomains included in the microfine structure is transferred on the surface of the substrate to form protrusion/indention shapes. Herein, the patterned substrate may be a master or a copy thereof.

### Effect of the Invention

The present invention provides the process for producing the microfine structure including the microstructures using the chemical registration method. In this process, it is possible to effectively complement the chemical pattern disposed sparsely on the substrate by undergoing the self-organization of the polymer film. This allows producing the microfine structure comprising the microphase separated structure having a good long-distance regularity and less defects.

### BRIEF DESCRIPTION OF THE DRAWINGS

FIG. 1 is a schematic diagram showing a concept of the chemistry registration method.

FIGS. 2A to 2E are schematic diagrams showing a process of the present invention.

FIGS. 3A and 3B are schematic diagrams showing examples of the inside structure of the block copolymer undergoing microphase separation on the substrate.

FIGS. 4A to 4H are schematic diagrams showing a process of chemically pattering the substrate.

FIGS. 5A to 5C are schematic diagrams each showing a cross-section of the chemically patterned substrate.

FIGS. 6A1 to 6B2 are schematic diagrams showing arrangements of the chemical pattern of the substrate and the chemical registration method using the corresponded substrates.

FIGS. 7A to 7D are schematic diagrams each showing an embodiment of the present invention.

FIGS. 8A to 8F are schematic diagrams showing a process for producing the patterned substrate of the present invention.

FIGS. 9A to 9C are schematic diagrams showing a pattern arrangement of the substrate in the example of the present invention.

FIG. 10A is a SEM (scanning electron microscopy) image of the pattern formed from the block copolymer composition.

FIG. 10B is a 2-dimensional Fourier transform image of the SEM image of FIG. 10A.

FIGS. 11A to 11C are SEM images of the pattern formed from the block copolymer composition on the substrate surface treated with the chemical patterning thereon.

FIGS. 12A to 12C are diagrams showing a pattern arrangement on the substrate in the example of the present invention.

### DETAILED DESCRIPTION OF THE PREFERRED EMBODIMENT

Next, embodiments of the present invention will be explained in reference to the attached drawings. Hereinafter, the embodiments will be explained on mainly cylindrical microdomains. However, embodiments of lamellar microdomains may be also implemented in the similar way.

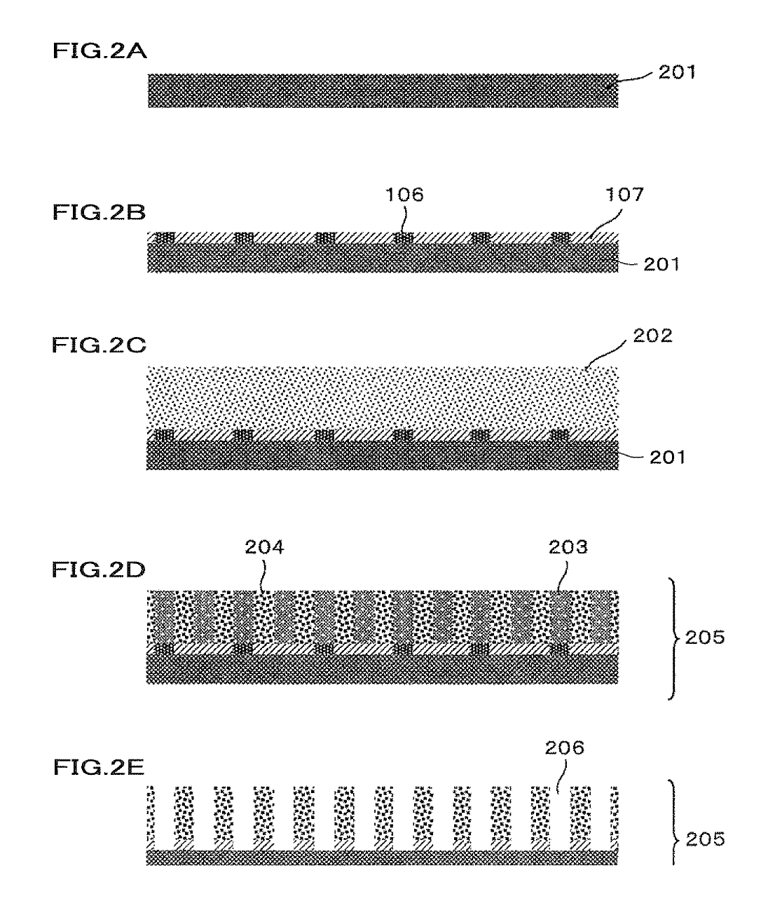

FIGS. 2A to 2E show a process for producing a polymer film in which cylindrical microdomains are disposed standing upright on a substrate according to the present invention (referred to a chemical registration method). Each step will be described in detail hereinafter.

FIG. 2A shows a substrate 201 used to form the polymer film thereon in which the cylindrical microdomains are disposed standing upright on the substrate. Next, as shown in FIG. 2B, a pattering process is conducted on the substrate 201 to form a first surface 106 and a second surface 107, having a different chemical property each other. As shown in FIG. 2C, a film of a high-weight molecule block copolymer (referred to polymer film 202) is formed so that the film has a predetermined thickness “t”. As shown in FIG. 2D, by undergoing microphase separation of the high-weight molecular block copolymer, microstructures are formed comprising a first segment of a continuous phase 204 and a second segment of a cylindrical microdomain 203. Finally, as shown in FIG. 2E, the polymer film 202 (referred to microfine structure 205) including the microstructures may be formed by removing either of the block copolymer chains to form micropores 206.

Herein, the chemical properties of the first surface 106 and the second surface 107 are designed as follows. That is, in the first surface 106 prepared at a stage shown in FIG. 2B, a first material of the first segment is designed to have better wettability than a second material of the second segment. Similarly, in the second surface 107, a second material of the second segment is designed to have better wettability than the first material of the first segment. Further, the thickness of the film is controlled in a predetermined range. By designing and controlling as mentioned above, the first segment and the second segment may be regularly arranged on the first surface 106 and the second surface 107 as shown in FIG. 2D. Herein, if the wettability is represented by interfacial tension, the first surface 106, in which the interfacial tension with the first material of the first segment is smaller than the interfacial tension with the second material of the second segment, may be arranged on the second surface 107, in which the interfacial tension with the second material of the second segment is smaller than the interfacial tension with the first material of the first segment. In other words, the first surface 106 and the second surface 107 may be arranged so that the interfacial tension with the first surface 106 of the first material of the first segment is smaller than the interfacial tension with the first surface 106 of the second material of the second segment, and the interfacial tension with the second surface 107 of the second material of the second segment is smaller than the interfacial tension with the second surface 107 of the first material of the first segment. Here, a relationship of the wettability or the interfacial tension among the first surface 106, the second surface 107 on the substrate 201, and the first and second segments of the block copolymer may satisfy the above mentioned condition at the temperature when the phase separation of the block copolymer is performed. By setting the relationship as described above, it is possible to form a structure in which the first segment is regularly arranged on the first surface 106, and the second segment is regularly arranged on the second surface 107.

In the step shown in FIG. 2C, a relationship between the thickness “t” of the polymer film and the intrinsic periodicity “d₀” of the microstructures which are to be formed through the microphase separation of the block copolymer in a bulk state thereof, preferably satisfies the following equation:

(m+0.3)×d₀<t<(m+0.7)×d₀(m is an integer of 0 or more)

Accordingly, even if pattern members are sparsely disposed in the positions where the microdomains are to be formed, a region positioned between the pattern members may be complemented, allowing the cylindrical microdomain 203 to be formed in the region where no pattern member is present, as shown in FIG. 2D.

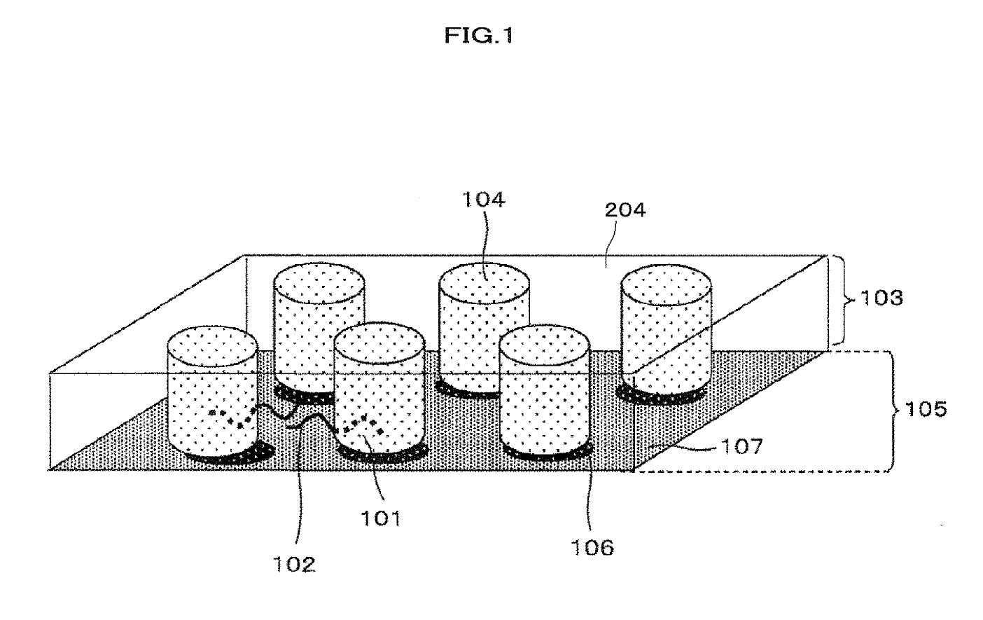

Here, as shown in FIGS. 1A to 2E, microdomains formed in the polymer film are shown as cylindrical microdomains 104 and 203 which are arranged in a thickness direction of the coated film. However, the microdomain in the microfine structure of the present invention is not limited to the above mentioned cylindrical embodiment. For example, the embodiment of the present invention may comprise all shapes of the microdomain as long as the microdomain is formed from the block copolymer. For example, in another embodiment, the microdomain may have a layered shape (or lamellar shape).

Similarly, in the continuous phase 204 formed in the polymer film (or coated film) shown in FIGS. 1A to 2E, the cylindrical microdomains 104 and 203 are disposed sparsely and uniformly in a thickness direction of the polymer film to form a regularly arranged pattern. However, the continuous phase of the microfine structure of the present invention is not limited to the above mentioned embodiment. For example, any type may be defined as a continuous phase as long as the continuous phase is formed in the regions where it shares an interface with the microdomains taking a variety of shapes.

Hereinafter, a material used in the process for producing the polymer film comprising the microstructures of the present invention will be described in detail.

(Block Copolymer)

When cylindrical microdomain structures are used, the degree of polymerization of the second segment of the block copolymer is preferably smaller than the degree of polymerization of the first segment. Further, the distribution of the molecular weight of the high-molecular weight block polymer is preferably has a narrow range. By controlling the degree of polymerization, the shape of the boundary at the connecting part of the first and the second segments tends to have a cylindrical shape, thereby to form a region of the continuous phase 204 (see FIG. 2D) made of the second segment and a region of the cylindrical microdomain 203 (see FIG. 2D) made of the first segment as a main component. Note the degree of polymerization of the second segment may be adjusted to be equal to the degree of polymerization of the first segment of the block copolymer, when lamellar microdomain structures are used.

The block copolymer satisfying the above mentioned conditions includes polystyrene-block-polymethyl methacrylate copolymer (hereinafter, referred to PS-b-PMMA) and polystyrene-block-polydimethylsiloxane (hereinafter, referred to PS-b-PDMS). However, the block copolymer of the present invention is not limited to the above mentioned copolymers and other combinations of polymers may be used in a wide range as long as the copolymer undergoes microphase separation.

Here, the block copolymer may be synthesized by an appropriate synthetic method, preferably by a synthetic method which may allow distribution of the molecular weight to be as narrow as possible, so as to improve the regularity of the microdomains. A living polymerization method is one of the examples applicable to the synthesis.

In the present embodiment, an AB type of the block copolymer is shown as an example, which is formed by connecting the end of the first segment with the end of the second segment. However, the present embodiment of the block copolymer is not limited to the above mentioned type, and may include an ABA type of the high-molecular weight tri-block copolymer, a linear type of the block copolymer such as an ABC type of the block copolymer made of three and more types of polymer segments, or a star type of the block copolymer.

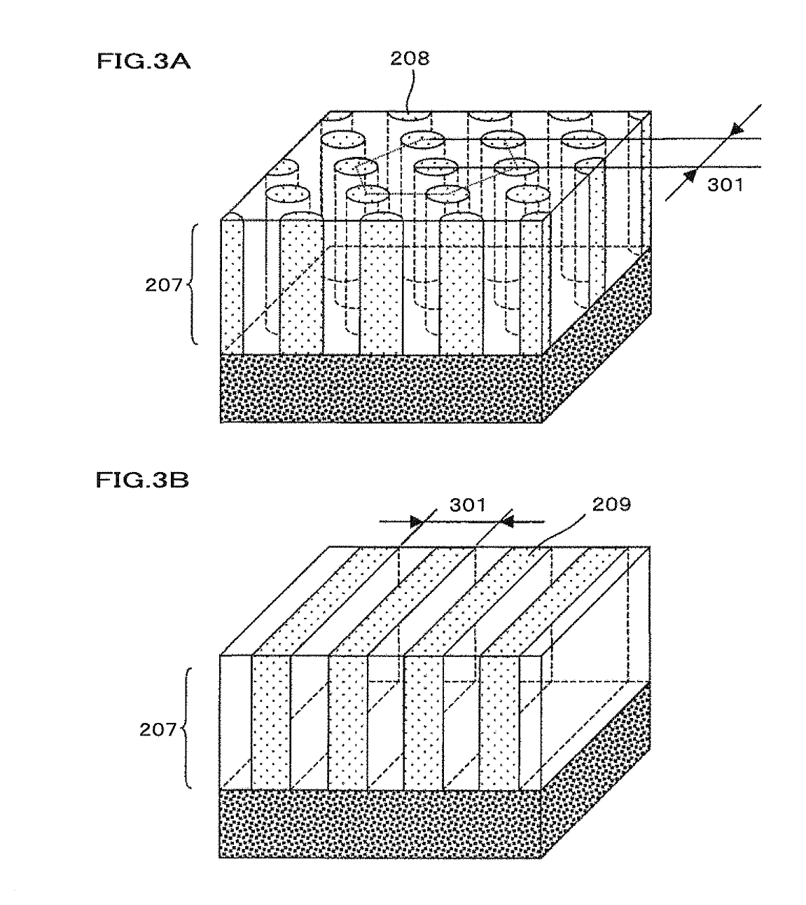

Here, the block copolymer of the present invention forms cylindrical structures through undergoing microphase separation. As described previously, s size of the cylindrical structure is defined corresponding to the molecular weight of the high-molecular eight block copolymer. That is, the size of the cylindrical structure formed from the block copolymer has an intrinsic dimension corresponding to the molecular weight of the polymer composing the block copolymer. Here, a periodicity of the regular structure formed through the microphase separation is defined as “d₀”. If the microdomain has a cylindrical shape, cylindrical microdomains 208 are regularly disposed as being packed hexagonally as shown in FIG. 3A. In the case, an intrinsic periodicity “d₀” shown as a reference sign 301 is defined as a lattice distance of the hexagonal arrangement. If the microdomain has a lamellar shape, lamellar shaped microdomains 209 are regularly disposed by being packed in parallel as shown in FIG. 3B. In the case, an intrinsic periodicity “d₀” shown as a reference sign 301 is defined as a distance between the lamellas. Note the intrinsic periodicity “d₀” is defined as a periodicity of the microstructures when the block copolymer is caused to undergo the microphase separation on the surface of the substrate on which no chemical pattern is formed.

(Substrate)

In the chemical registration method, as shown in FIG. 2B, a surface of the substrate 201 is patterned to form a first surface 106 and a second surface 107 having a different chemical property each other. Then, as shown in FIG. 2D, the cylindrical microdomains 203 and the continuous phase 204 formed from the block copolymer are respectively disposed on the first surface 106 and the second surface 107, thereby to control the microdomains. Hereinafter, is described a process for pattering the surface of the substrate 201 to form the first surface 106 and the second surface 107 having a different chemical property each other.

Here, a material of the substrate 201 shown in FIG. 2A is not limited to a specific one and may be selected for purposes. For example, the material of the substrate 201 may be selected from an inorganic material such as glass and titania, a semiconductor material such as silicon and GaAs, a metallic material such as cupper, tantalum and titan, and an organic material such as epoxy resin and polyimide.

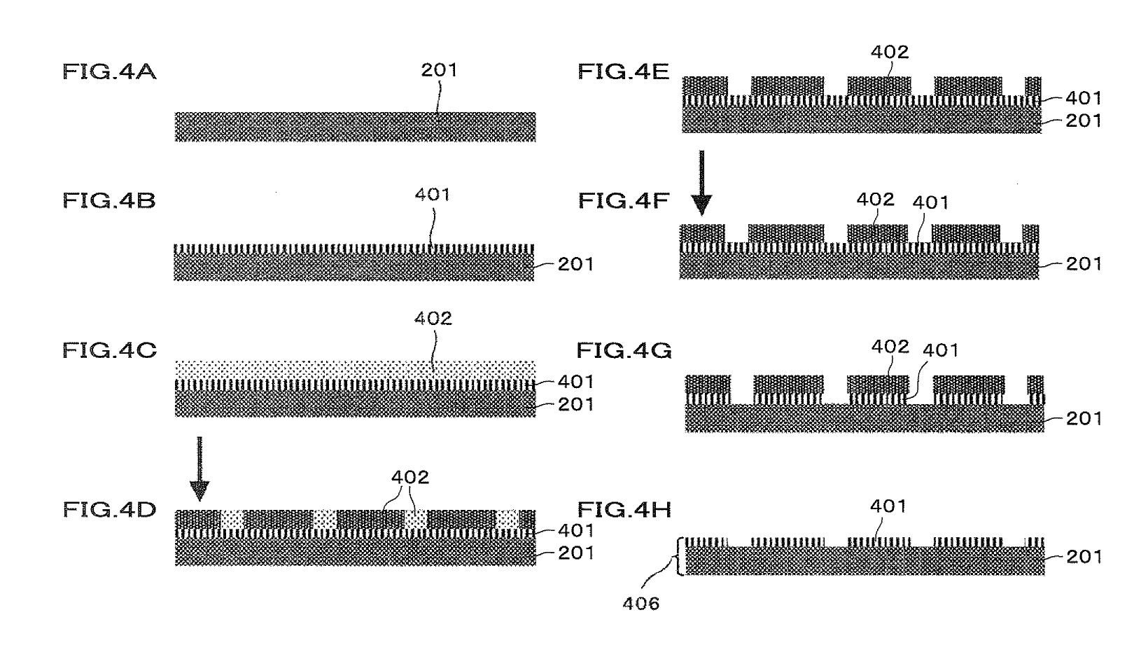

Next, in an embodiment, referring to FIGS. 4A to 4H, a process for pattering the surface of the substrate 201 to form the first surface 106 and the second surface 107 having a different chemical property each other will be described. In this embodiment, PS-b-PMMA is a main component of the block copolymer, and through the microphase separation of the block copolymer, maicrodomains made of polystyrene (PS) as a main component and microdomains made of polymethyl methacrylate (PMMA) as a main component are produced.

As shown in FIG. 4A, the surface of the substrate 201 is chemically modified so that the entire surface of the substrate 201 is more wettable with polystyrene (PS) than polymethyl methacrylate (PMMA). For the chemical modification, a method for forming a single molecule film using silane coupling and a polymer grafting method may be used. Herein, the phenethyl group may be introduced onto the surface of the substrate 201 by a coupling reaction of phenyl trimethoxysilane in the case of the single molecule film formation so that the surface of the substrate 201 has a good affinity to polystyrene (PS). Similarly, in the case of the polymer modification, the polymer compatible with polystyrene (PS) may be introduced onto the surface of the substrate 201 by a grafting treatment.

The grafting treatment of the polymer comprises steps of: first introducing a chemical group from which polymerization starts onto the surface of the substrate 201 through the coupling reaction, and starting the polymerization from the chemical group. Alternatively, the treatment is performed by steps of: preparing a polymer comprising a functional group which may chemically couple with the surface of the substrate 201 at the end of or at the main chain of the polymer, and then coupling the polymer with the surface of the substrate 201. Herein, the latter treatment is more simple and preferable.

Next, in an embodiment, a method for grafting polystyrene (PS) on the silicon surface will be described more specifically, in which the surface of the substrate 201 made of silicon is grafted so that the surface has a good affinity to polystyrene (PS). First, polystyrene (PS) having a hydroxyl group at the end of the polymer is prepared by the established living polymerization reaction. Next, the substrate 201 is exposed to an oxygen plasma or immersed into a piranha solution to thereby increase the density of hydroxyl groups on a surface of a naturally oxidized layer of the substrate 201 surface. Then, polystyrene (PS) having a hydroxyl group at the end of the polymer is solved in a solvent such as toluene, and deposited on the substrate 201 surface by spin-coating and so forth. Then, the substrate 201 thus obtained is heated in a vacuum oven for about 72 hr, at about 170° C. in vacuo. This treatment may promote the dehydration condensation between the hydroxyl group on the substrate 201 surface and the hydroxyl group at the end of the polystyrene (PS), which allows connecting the polystyrene (PS) near the substrate 201 surface with the substrate 201. Finally, the substrate 201 is washed by a solvent such as toluene to remove polystyrene (PS) unconnected with the substrate 201 surface, producing the substrate 201 made of silicon, which is grafted by polystyrene (PS).

When a polymer is grafted on the surface of the substrate 201, a molecular weight of the polymer to be grafted is not limited to a specific value. However, if the molecular weight of the polymer is set between about 1,000 to about 10,000, an extremely thin film of the polymer may be formed on the substrate 201 surface to have a thickness of several nanometers by the grafting treatment as mentioned above.

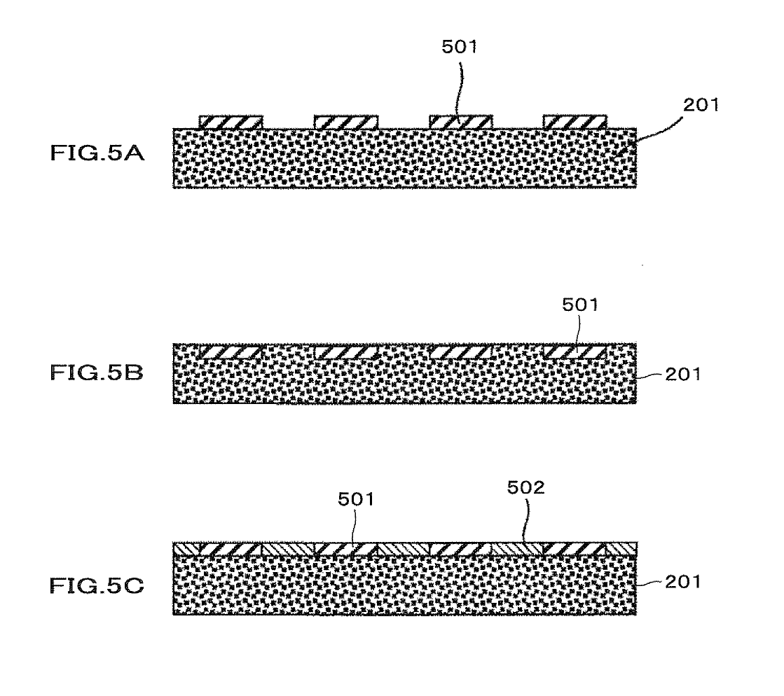

Next, a chemically modified layer 401 (see FIG. 4B) disposed on the substrate 201 surface is patterned. For the patterning procedure, known patterning techniques may be applied corresponding to a desirable patterned size, including photolithography and electron beam direct writing. For example, as shown in FIG. 4B, a chemically modified layer 401 is formed on the surface of the substrate 201, then a resist layer 402 is formed on the surface of the layer 401 as shown in FIG. 4C. Then, as shown in FIG. 4D, the resist layer 402 (see FIG. 4C) is patterned by exposing light, and after a developing treatment (FIG. 4E), the resist layer 402 thus developed becomes a mask. Then, as shown in FIGS. 4F and 4G, the chemically modified layer 401 may be patterned by an etching treatment such as an oxygen plasma treatment. Finally, the resist layer 402 remained on the chemically modified layer 401 as shown in FIG. 4G is removed to provide a chemically patterned substrate 406 comprising the chemically modified layer 401 which is patterned as shown in FIG. 4H. Note the above mentioned process is an example and other process may be used as long as the chemically modified layer 401 disposed on the substrate 201 surface may be patterned. Here, in the process shown in FIGS. 4A to 4H, the chemically modified layers 401 are disposed sparsely on the substrate 201 surface. Therefore, as shown in FIG. 5A, a cross-section of the substrate 201 thus obtained shows a structure in which thin films (chemically modified layers 501) having a different chemical property from the substrate 201 are formed on the substrate 201 surface. However, according to the present invention, as shown in FIGS. 5B and 5C, other types of the substrate 201 may be used. In an embodiment of FIG. 5B, a chemically modified layers 501 having a different chemical property in a surface sate thereof from the substrate 201 may be sparsely embedded in the substrate 201. Further, in another embodiment of FIG. 5C, two types of thin films (chemically modified layers 501 and 502) having different chemical properties may be patterned to be disposed on the substrate 201 surface.

In the process shown in FIGS. 4A to 4H, the substrate 201 is produced comprising a polystyrene modified layer (chemically modified layer 401) which is patterned on the surface of the substrate 201 made of silicon. Here, the surface of the substrate 201 is patterned to form a first surface 106 where silicon is exposed (see FIG. 2B) and a second surface 107 composed of polystyrene modified layer (chemically modified layer 401) (see FIG. 2B). Note the surface of silicon has more affinity to polymethyl methacrylate (PMMA) than polystyrene (PS). Accordingly, this results in forming a surface with selectivity to the microdomains mainly composed of polystyrene (PS) and another surface with selectivity to the microdomains mainly composed of polymethyl methacrylate (PMMA), both microdomains being formed from the block copolymer mixture including PS-b-PMMA as a main component.

As mentioned above, the patterning process of the substrate 201 surface has been described, in which the block copolymer mixture including PS-b-PMMA as a main component is used. However, other block copolymer mixture may be used to chemically pattern the substrate 201 surface in the similar procedure.

(Chemical Registration Method)

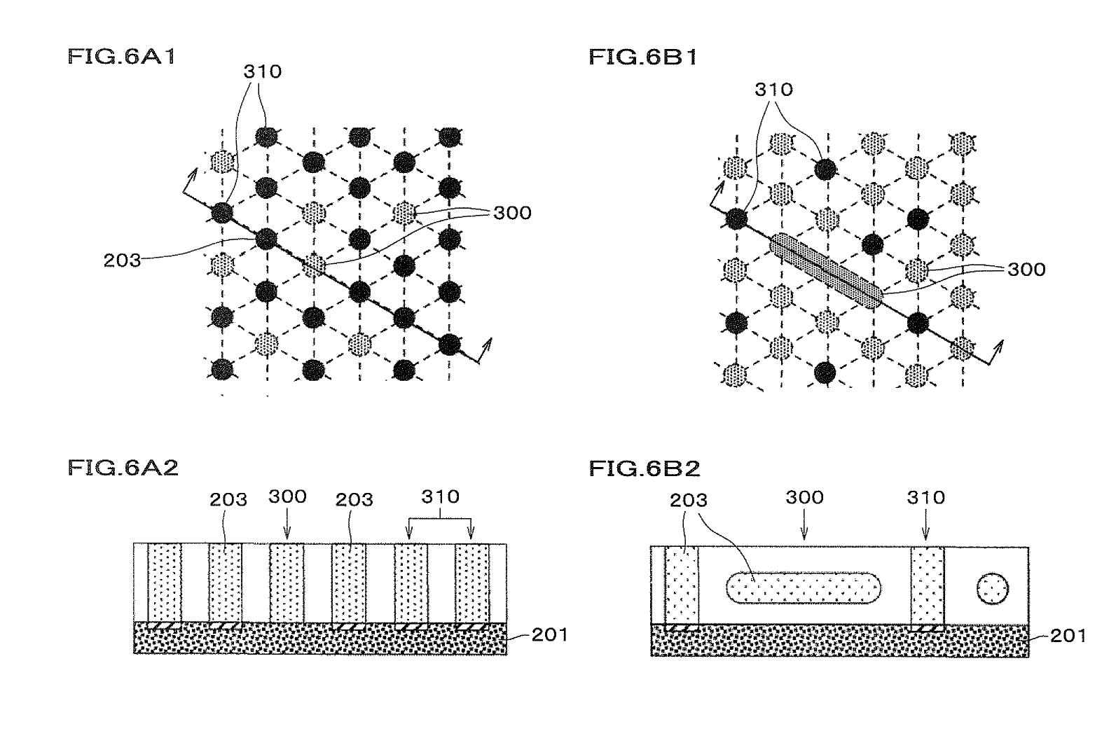

A chemical registration method is a process for improving a long-distance regularity of microdomains formed through self-organization of a block copolymer by using a chemical mark (or chemical pattern) arranged on a substrate surface. Here, in the chemical registration method, defects of the chemical mark may be complemented when the block copolymer undergoes a self-organization phenomenon. For example, in an embodiment, a block copolymer may be used to intrinsically form cylindrical microdomains regularly disposed hexagonally with a lattice distance “d₀”. As shown in FIGS. 6A1 and 6A2, when the chemical mark has defects, the cylindrical microdomains 203 formed from the block copolymer surrounding the pattern defect positions 300 may restrict the structure of the block copolymer at the pattern defect positions 300, facilitating the cylindrical microdomains 203 to be disposed standing upright on the substrate 201. This allows the pattern defect positions 300 to be complemented. However, as shown in FIGS. 6B1 and 6B2, when the rate of the pattern defect positions 300 is 50% and more, the cylindrical microdomains 203 at the pattern defect position 300 take a structure lying down parallel to the substrate 201. This may be caused because cylindrical portions of the cylindrical microdomains 300 are assembled together near the substrate 201 surface having a lot of pattern defect positions 300, which results in forming a cylindrical structure lying down parallel to the substrate 201.

The present invention provides a process for complementing the chemical pattern (or pattern defect position 300) through the chemical registration method. The process comprises steps of: controlling a thickness of a film of the block copolymer, and disposing the cylindrical microdomains 203 standing upright on the substrate 201, which results in improvement of a long-distance regularity and decrease of defects of the microdomains. Preferably, in the process, the chemical pattern and the microdomains formed from the block copolymer may satisfy the relationship of n: 1 (n is a positive number of 2 and more).

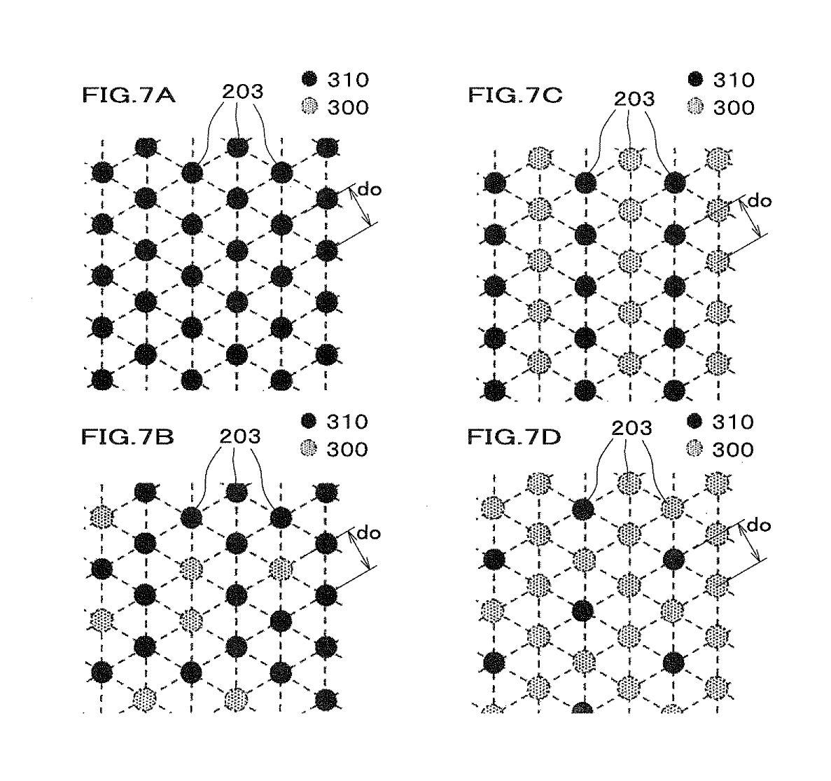

Next, representative examples of the chemical pattern will be described, in which the chemical pattern (or pattern defect position 300) may be complemented by using the chemical registration method of the present invention. FIGS. 7A to 7D show chemical patterns in which the chemical pattern may be complemented when the intrinsic periodicity of the microdomains formed from the block copolymer is “d₀”. Herein, FIGS. 7A to 7D are diagrams corresponding to FIG. 6A, showing the state that a rate of a chemical pattern drawing position 310 and a chemical pattern complemented position is changed.

FIG. 7A shows a pattern in which the cylindrical microdomains 203 are disposed all over the substrate 201 surface in a hexagonal structure with an intrinsic periodicity “d₀”, standing upright on the substrate 201 (see FIG. 6A2). In this pattern, there are no pattern defect position 300 on the substrate 201 surface that has been chemically patterned in the same shape as FIG. 7A (see FIGS. 6A1 and 6A2). This allows the use of the conventional registration method.

FIG. 7B shows a pattern in which the cylindrical microdomains 203 are disposed all over the substrate 201 surface in a hexagonal structure with an intrinsic periodicity “d₀”, standing upright on the chemically patterned substrate 201. Here, the rate of the pattern defect positions 300 (or chemical pattern complemented positions) is 25% (see FIG. 6A2). In this pattern, a cylindrical microdomain 203 at the pattern defect position 300 in FIG. 7B is restricted by other cylindrical microdomains 203 standing upright on the substrate 201 surrounding the above mentioned microdomain. This facilitates the cylindrical microdomain 203 at the pattern defect position 30 to form a structure standing upright on the substrate 201. Accordingly, the cylindrical microdomains 203 are disposed all over the substrate 201 surface standing upright thereon, which allows the use of the conventional chemical registration method.

FIG. 7C shows a pattern in which the cylindrical microdomains 203 are disposed all over the substrate 201 surface in a hexagonal structure with an intrinsic periodicity “d₀”, standing upright on the substrate 201 which has pattern defect positions 300 (or chemical pattern complemented positions) in every other line (see FIG. 6A2). Herein, a density of the chemical pattern on the substrate 201 is 50% (see FIG. 6A2), resulting in a weak restricting ability of the microdomains 203 standing upright on the substrate 201 surface. However, when the thickness “t” of the film of the block copolymer satisfies the following relationship, a chemical registration having a good precision may be achieved, even if the density of the chemical pattern is 50%.

(m+0.3)×d₀<t<(m+0.7)×d₀, where m is an integer of 0 or more).

FIG. 7D shows a pattern in which the cylindrical microdomains 203 are disposed all over the substrate 201 surface in a hexagonal structure with an intrinsic periodicity “d₀”, standing upright on the chemically patterned substrate 201. Here, the pattern defect positions 300 (or chemical pattern complemented positions) are arranged so that the periodicity is two times of the intrinsic periodicity “d₀” (see FIG. 6A2). Herein, a density of the chemical pattern on the substrate 201 (see FIG. 6A2) is 25%, resulting in a weak restricting ability of the microdomains 203 standing upright on the substrate 201 surface. However, when the thickness “t” of the film of the block copolymer satisfies the following relationship, a chemical registration having a good precision may be achieved, even if the density of the chemical pattern is 25%.

(m+0.3)×d₀<t<(m+0.7)×d₀, where m is an integer of 0 or more).

(Deposition of Block Copolymer Composition and Microphase Separation Thereof)

A block copolymer composition is deposited on the chemically patterned substrate prepared as mentioned above, to undergo microphase separation thereof. The procedure will be described hereinafter.

First, the block copolymer composition is solved in a solvent to form a dilute solution of the block copolymer composition. Then, as shown in FIG. 2C, a coated film 202 is obtained by deposition of the block copolymer composition on the surface of the chemically patterned substrate 201. Herein, the depositidn process is not limited to the above mentioned embodiment, and other methods such as spin coating and dip coating processes may be used. When the spin coating process is used, a film of the block copolymer composition with a thickness of several tens nanometers in size may be stably obtained, typically under the conditions: solution wt % concentration: several wt %; rotational speed of the spin coating: 1000-5000 rpm.

Here, it is important that the thickness “t” of the block copolymer composition satisfies the relationship defined by the following equation:

(m+0.3)×d₀<t<(m+0.7)×d₀, where m is an integer of 1 or more; d₀ is an intrinsic periodicity).

In the equation, the maximum value of m is not limited to a specific one. However, preferably m is an integer in the range from 1 or more to 5 or less, so that the maximum value of m is within about 5 times of the intrinsic periodicity “d₀” of the block copolymer composition. This allows the effect of the chemical registration to be the maximum.

A structure of the block copolymer composition deposited on the surface of the substrate patterned chemically, does not generally have an equilibrium structure, although it depends on the deposition method. For example, when the microphase separation of the block copolymer composition is not sufficiently performed in association with a rapid vaporization of the solvent during the deposition process, in many cases, the structure of the block copolymer composition may be produced in the non-equilibrium state or in the completely disordered state. Therefore, an annealing method may be applied to the substrate so that the microphase separation of the block copolymer composition is sufficiently performed to obtain the equilibrium structure thereof. The annealing method includes thermal annealing and solvent annealing procedures. In the thermal annealing, the substrate is left in the state heated at more than the glass transition temperature of the block copolymer composition. In the solvent annealing, the substrate is left in the state exposed by a vapor of a solvent solubilizing the block copolymer composition. When a block copolymer composition comprising PS-b-PMMA as a main component is used, the thermal annealing is a more convenient procedure. The substrate is annealed by being heated for several hours to several days at 170-200° C. in vacuo.

(Patterned Substrate)

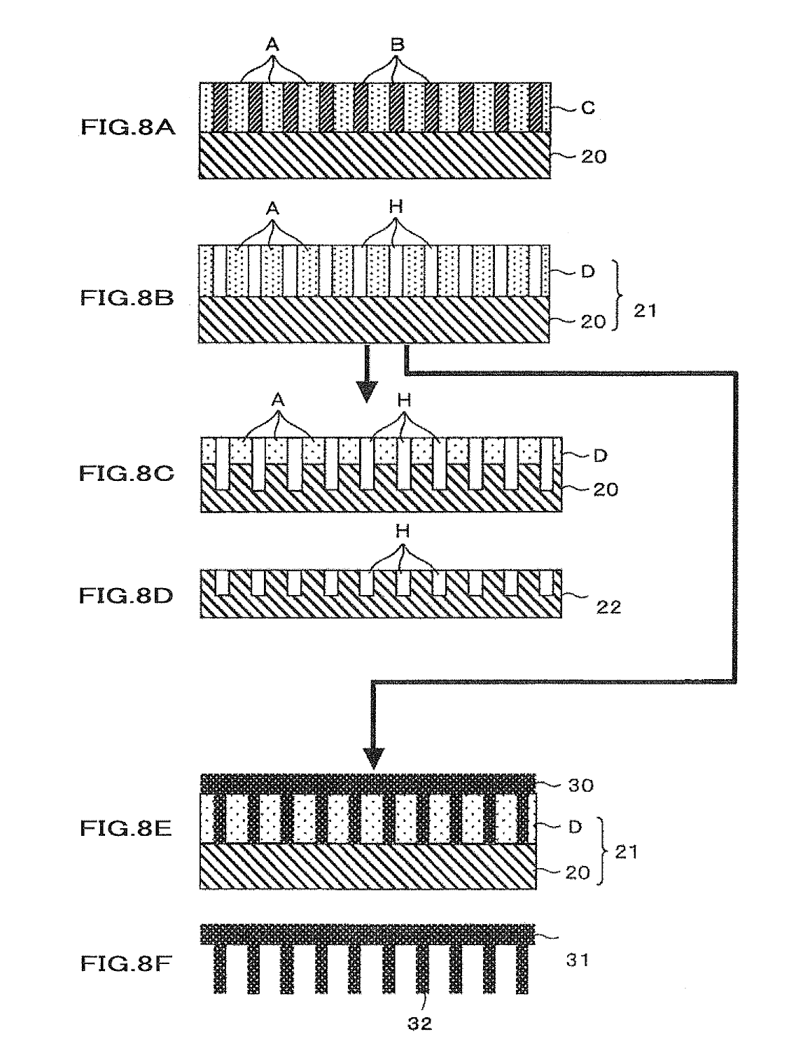

Next, referring to FIGS. 8A to 8F, a variety of processes for producing a patterned substrate by using the microdomains of the block copolymer composition will be described. Here, in FIGS. 8A to 8F, a surface with a different chemical property patterned on the surface of the substrate 20 is omitted. Note the patterned substrate is defined as a substrate on which a protrusion/indentation patterned surface is formed corresponding to a regularly arranged pattern of the microdomains.

In an embodiment, first, either of the polymer phases (for example, cylindrical phase B) is selectively removed from the microdomains (composed of continuous phase A and cylindrical phase B) shown in FIG. 8A, to produce a porous film D in which a regularly arranged pattern of a plurality of micropores H are formed as shown in FIG. 8B.

Alternatively, a polymer film in which a regularly arranged pattern of a plurality of cylindrical structures (cylindrical phase B) is formed may be produced by selectively removing the polymer phase of the continuous phase A (the process is not shown). As described above, the porous film D in which the regularly arranged pattern of the plurality of the micropores H or cylindrical structures is formed may be created on the substrate 20, to thereby produce the patterned substrate (microfine structure 21).

In another embodiment, as shown in FIG. 8B, a porous film D may be obtained by peeling the remaining other polymer phase, which is a porous film D comprised of a continuous phase A in FIG. 8B, from the surface of the substrate 20. This porous film D may be used as a patterned substrate (microfine structure 21).

Here, as shown in FIG. 8B, a method for selectively removing either of the polymer phases, the continuous phase A or the cylindrical phase B, composing the polymer film C includes reactive ion etching (RIE) or other etching procedures performed by a difference of etching rate between the respective polymer phases.

The block copolymer that forms a polymer film from which either of the polymer phases may be selectively removed, comprises: polybutadiene-block-polydimethylsiloxane, polybutadiene-block-poly-4-vinylpyridine, polybutadiene-block-polymethyl methacrylate, polybutadiene-block-poly-t-butyl methacrylate, polybutadiene-block-poly-t-butylacrylate, poly-t-butylmethacrylate-block-poly-4-vinylpyridine, polyethylene-block-polymethyl methacrylate, poly-t-butyl methacrylate-block-poly-2-vinylpyridine, polyethylene-block-poly-2-vinylpyridine, polyethylene-block-poly-4-vinylpyridine, polyisoprene-block-poly-2-vinylpyridine, polymethyl methacrylate-block-polystyrene, poly-t-butyl methacrylate-block-polystyrene, polymethyl acrylate-block-polystyrene, polybutadiene-block-polystyrene, polyisoprene-block-polystyrene, polystyrene-block-poly-2-vinylpyridine, polystyrene-block-poly-4-vinylpyridine, polystyrene-block-polydimethylsiloxane, polystyrene-block-poly-N,N-dimethylacrylamide, polybutadiene-block-sodium polyacrylate, polybutadiene-block-polyethylene oxide, poly-t-butyl methacrylate-block-polyethylene oxide, polystyrene-block-polyacrylic acid, and polystyrene-block-polymethacrylic acid or the like.

In another embodiment, the etching selectivity may be improved by doping metallic atoms to either of the polymer phases, the continuous phase A or the cylindrical phase B. For example, when the block copolymer is composed of polystyrene and polybutadiene, the polymer phase of polybutadiene is more easily doped with osmium than the polymer phase of polystyrene. This effect may increase the resistance to the etching treatment of the microdomains made of polybutadiene.

Next, other embodiments of the process for producing the patterned substrate will be described referring to FIGS. 8C and 8D. In an embodiment, the substrate 20 is etched by RIE or a plasma etching method using the remained other polymer phase (porous film D) such as the continuous phase A as a mask. As shown in FIG. 8C, a position of the substrate 20 surface corresponding to a position of the polymer phase selectively removed through a micropore H is etched, thereby to transfer the regularly arranged pattern of the microphase separated structure on the surface of the substrate 20. Then, the polymer film D remained on the surface of the substrate 22 is removed by RIE or a solvent, to produce the patterned substrate 22 on which the micropores H are formed having the regularly arranged pattern corresponding to the cylindrical phases B (see FIG. 8A) as shown in FIG. 8D.

Next, other embodiments of the process for producing the patterned substrate will be described referring to FIGS. 8E and 8F.

The remained other polymer phase (porous film D) such as the continuous phase A in FIG. 8B is pressed onto the transferring object 30 as shown in FIG. 8E, to transfer the regularly arranged pattern of the microdomains on the surface of the transferring object 30. Then, the transferring object 30 is peeled from the microfine structure 21. Accordingly, as shown in FIG. 8F, a replica (patterned substrate 31) on which the regularly arranged pattern of the porous film D (see FIG. 8E) is produced.

Herein, the material of the transferring object 30 may be selected based on the application, including a metallic material such as nickel, platinum and gold, and an inorganic material such as glass and titania. When the transferring object 30 is made of metal, the transferring object 30 may be pressed on the protrusion/indentation patterned surface of the microfine structure 21 by spattering, deposition, plating procedures, and combinations thereof.

Further, when the transferring material 30 is made of an inorganic material, the transferring object 30 may be pressed on the protrusion/indentation patterned surface of the microfine structure 21 by a sol-gel procedure in addition to spattering and CVD procedures. Here, in the plating and sol-gel procedures, an extremely small regularly arranged pattern with several tens nanometers in size of the microdomains may be precisely transferred. These procedures are preferable because the manufacturing costs may be reduced by using a non-vacuum process.

The microfine structure 21 produced by the above mentioned process has an extremely fine protrusion/indentation surface of the regularly arranged pattern formed on the surface of the microfine structure, and a large aspect rate. Therefore, the microfine structure 21 may be used in a variety of applications.

For example, the surface of the microfine structure 21 thus produced is repeatedly pressed on a number of transferring objects 30 by using a nanoimprinting method. This allows the microfine structure 21 to be used in the application in which a large number of replicas of the patterned substrate 31 with the same regularly arranged pattern on the surface may be manufactured.

Hereinafter, processes for transferring the extremely fine regularly arranged pattern on the protrusion/indentation surface of the patterned substrate onto a transferring object by the nanoimprinting method will be described.

In a first process, the patterned substrate thus produced is directly imprinted to the transferring object (not shown) to transfer the regularly arranged pattern. This process is referred to a thermal imprinting method, which is preferable when the transferring object is made of a material which may be directly imprinted. For example, when the transferring object is made of a thermoplastic resin represented as polystyrene (PS), the process may comprise steps of: heating the transferring object over the glass transition temperature of the thermoplastic resin; pressing the patterned substrate onto the transferring object; and peeling the patterned substrate from the surface of the transferring object after cooling them below the glass transition temperature, thereby to produce a replica thereof.

Further, in a second process, when the patterned substrate is made of a light transpiring material such as glass, photocurable resin is used for the transferring object (not shown). This method is referred to a photo-imprinting method. In this method, after pressing the photopolymer onto the patterned substrate, the photocurable resin hardens on light irradiation. Then, the patterned substrate is peeled off and the hardening photocurable resin (or transferring object) may be used as a replica thereof.

Further, in the photo-imprinting method, when the transferred object (not shown) is, for example, a glass substrate, the photocurable resin is pressed between the piled layers of the patterned substrate and the glass substrate of the transferring object, and irradiated by light. Then, after the photocurable resin hardens, the patterned substrate is peeled off. The hardened photocurable resin with a protrusion/indentation patterned surface thereon is used as a mask to perform the etching fabrication by plasma or ion beams, which allows transferring the regularly arranged pattern on the surface of the transferring object.

(Patterned Medium for Magnetic Recording)

Next, in an embodiment of a device realized in the present invention, a medium for magnetic recording will be described. The medium for magnetic recording is always demanded so that the recording density of data therein is increasing. This may transform a size of a dot, a basic unit of the data, on the medium for magnetic recording into extremely small, and narrow the distance of the adjacent dots, achieving the high density state thereof.

Herein, it may be required for the periodicity of the arranged pattern of the dots to be set as about 25 nm, so as to configure the recording medium of which the recording density is 1 terabit/inch². As mentioned above, when higher density of the dots is required, there is a concern that magnetism provided to a single dot for determining ON/OFF may affect the adjacent dot.

Accordingly, a patterned medium has been developed in which regions of the dots on the medium for magnetic recording are physically divided, so as to exclude the effect of the magnetism leaking from the adjacent dot.

The present invention may be used in a process for producing the above mentioned patterned medium or a master for producing a patterned medium. Note it should be needed for the patterned medium that extremely small protrusion/indentation shapes are arranged regularly without any defect. Herein, the present invention may provide a process for effectively increasing a throughput thereof when the chemical pattern is drawn all over the surface of the disk.

As mentioned above, some embodiments of the present invention have been described in which the cylindrical microdomain structure is mainly included. However, the present invention may be applies to other embodiments in which the lamellar microdomain structure is included.

### Example

### Example 1

In this example, a process for producing a polymer film comprising a first microstructure of the present invention will be described. More specifically, in reference to Comparative Examples, results of the process will be described in which PS-b-PMMA is used as a block copolymer to form a cylindrical microdomain structure.

(Preparation of Chemically Patterned Substrate)

A silicon wafer having a natural oxide film was used for the substrate. Polystyrene was grafted on all over the surface of the substrate. Then, the polystyrene grafted layer was patterned by the electron beam (EB) lithography to produce the substrate in which the surface thereof was patterned to form regions each having a different affinity to polystyrene (PS) and polymethyl methacylate (PMMA). The detailed process will be described below.

The polystyrene grafted substrate was produced by the following procedure. First, a silicon wafer (4 inch) with a natural oxide film was washed by the piranha solution. In this step, the piranha solution may remove organic compounds from the surface of the substrate because of the oxidation activity thereof. Further, the piranha solution may oxidize the surface of the silicon wafer to increase a density of hydroxyl groups on the surface. Next, polystyrene was deposited on the surface of the silicon wafer (1.0 wt % concentration), in which the ends of the polystyrene were terminated by the hydroxyl group solved in toluene. Hereinafter, the polystyrene is referred to PS-OH. The deposition step was performed using a spin coater (MIKASA Co., 1H-360S) at a rotation speed of 3000 rmp. Herein, the molecular weight of PS-OH was 3700. The film thickness of PS-OH thus obtained was about 50 nm. Then, the substrate on which PS-OH was deposited was heated at 140° C. for 48 hr in a vacuum oven. In the step, the hydroxyl group at the end of PS-OH performed a dehydration reaction with the hydroxyl group of the surface of the substrate to form a chemical binding. Finally, unreacted PS-OH was removed by immersing the substrate in toluene and performing ultrasonication to produce a substrate having a polystyrene grafted layer.

Next, the thickness of the polystyrene grafted layer, the carbon content of the substrate surface, and the contact angle of the polystyrene (PS) for the substrate surface were determined so as to evaluate the surface state of the polystyrene grafted substrate. Herein, the thickness of the polystyrene grafted layer was measured by the spectroscopic ellipsometry method, and the carbon content of the surface was determined by the X-ray photoelectron spectroscopy method (XPS).

The contact angle of the polystyrene (PS) for the substrate surface was determined in the following method. First, a thin film of homopolystyrene (referred to hPS hereinafter) with the molecular weight of 4000 was sin-coated on the surface of the substrate so that the thickness of the film was about 80 nm. Next, the substrate on which hPS was deposited was annealed at 170° C. for 24 hr in vacuo. After the treatment, the hPS film was dewetted into extremely small droplets on the surface of the substrate. After the thermal treatment, the substrate was removed from a furnace, and rapidly cooled by immersing it in liquid nitrogen to keep the shape of the droplet through freezing. Then, the cross-sectional shape of the obtained droplet was measured by an atomic force microscope. The contact angle for the hPS substrate at the heating temperature was determined by measuring the angle between the substrate and the droplet interface. In the measurement, the angles were measured at six points and the contact angle was determined by the average of the angles.

As a result, the thickness of the grafted layer of the substrate surface on which polystyrene (PS) was grafted was 5.1 nm. Next, the carbon content of the substrate surface before and after the polystyrene grafting treatment was determined by XPS, thereby to give integral intensities of 45,00 cps and 27,000 cps for the peaks derived from the C1S thereof. Further, the contact angle of hPS was determined as 9°, which was smaller than the contact angle of 35° of the silicon wafer before the grafting treatment. Based on these results, the formation of the polystyrene grafted film on the surface of the silicon wafer was determined.

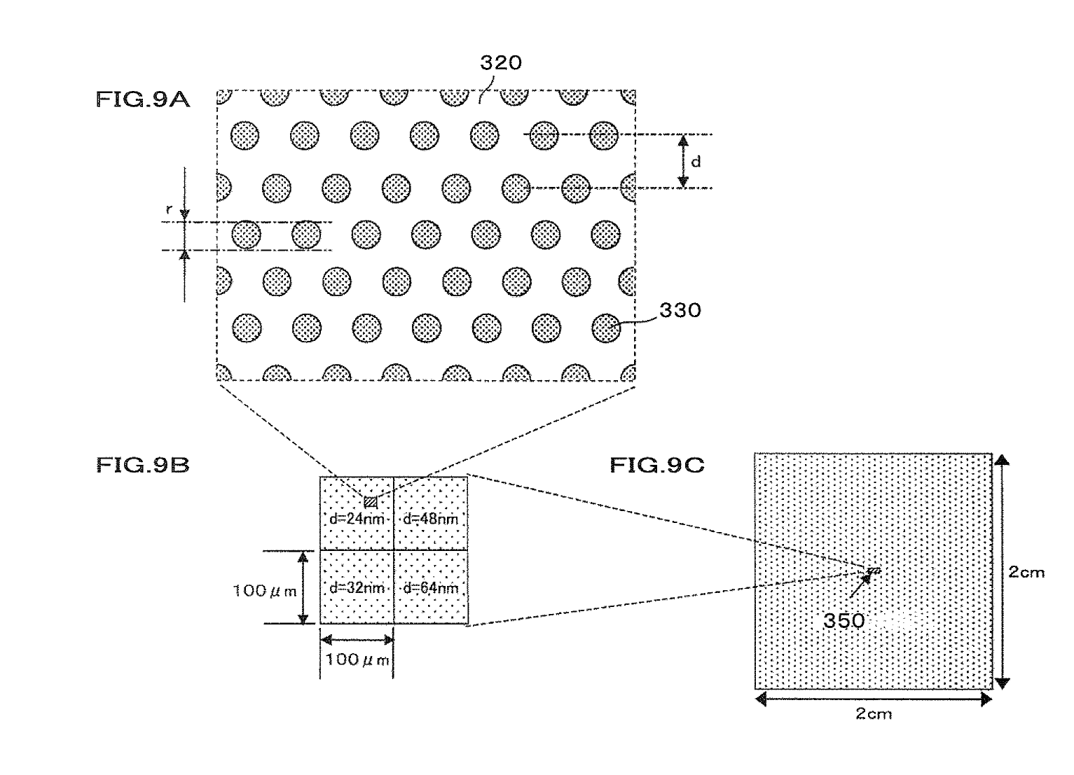

FIGS. 9A to 9C are schematic diagrams showing a pattern arrangement of a chemically patterned substrate. Here, a polystyrene grafted layer on a surface 320 of a polystyrene grafted substrate was patterned by the EB lithography method to produce a chemically patterned substrate. On the surface of the polystyrene grafted layer, circle shaped regions 330, in which a silicon wafer was exposed, having a diameter “r”, were arranged in a hexagonal structure with a lattice distance “d”. On one sheet of the substrate which was cut out from a patterned region 350 (2 cm×2 cm), the regions (100 μm×100 μm) with the hexagonal patterns having the lattice distances “d”: 24 nm, 48 nm, 32 nm, and 64 nm respectively were continuously arranged. The diameter “r” was set to be about 25-30% of the lattice distance “d”.

Next, referring to FIGS. 4A to 4H, a process for producing a chemically patterned substrate will be described schematically. First, a polystyrene grafted substrate (4 inch) (that is, substrate 201 on which chemically modified layer 401 was formed) prepared by the above mentioned method was diced to a 2 cm×2 cm plate (see FIG. 4B). Next, a PMMA resist (resist layer 402) was spin-coated on the surface of the substrate so that the thickness thereof was 85 nm (see FIG. 4C). Next, the PMMA resist was exposed to light by an EB drawing device at 100 kv (see FIG. 4D) and then the PMMA resist was developed (see FIG. 4E). Herein, a diameter “r” of the pattern was adjusted by the exposure level of the electron beams at each lattice point. Then, the polystyrene grafted layer (chemically modified layer 401) was etched by RIE using an oxygen gas, in which the patterned PMMA resist was used as a mask (see FIGS. 4F and 4G). The RIE treatment was performed by an ICP dry etching device under the following conditions: power: 40w, oxygen pressure: 4 Pa, gas flow rate: 30 cm³/min, etching time: 5-10 s. Finally, the PMMA resist (resist layer 402) remained on the substrate surface was removed by toluene, to produce the chemically patterned substrate 406 having the polystyrene grafted layer (chemically modified layer 401) on the surface thereof (see FIG. 4H).

(Measurement of Intrinsic Periodicity “d₀”)

The intrinsic periodicity “d₀” of each block copolymer (PS-b-PMMA) was determined by the following method. First, a sample of the PS-b-PMMA was solved in toluene of a semiconductor grade to prepare a PS-b-PMMA solution at the predetermined concentration of 1.0 wt %. Then, the PS-b-PMMA solution was spread on the surface of the silicon substrate by a spin coater so that a thickness of PS-b-PMMA was to be 45 nm. Then, the substrate was annealed at 170° C. for 24 hr in a vacuum oven undergoing a microphase separation process, thereby to form a self-assembled structure in the equilibrium state.

The microdomains in the film of PS-b-PMMA deposited on the substrate surface were analyzed by a scanning electron microscope (SEM).

The SEM analysis was performed by S4800 (Hitachi, Ltd.) at an acceleration voltage of 0.7 kv. The samples of the SEM analysis were prepared as follows. First, PMMA microdomains in the film of PS-b-PMMA were decomposed and removed by the oxygen RIE method, thereby to produce a polymer film comprising nano scale protrusion/indentation shaped structures derived from the microdomains. In the RIE method, RIE-10NP (SUMCO Inc.) was used under the following conditions: oxygen gas pressure: 1.0 Pa, gas flow rater 10 cm³/min, power: 20w, etching time: 30 sec. Herein, deposition of Pt on the sample surface generally performed for an antistatic treatment in the SEM analysis was not conducted so as to accurately determine the microstructure. Necessary contrast was achieved by controlling the acceleration voltage.

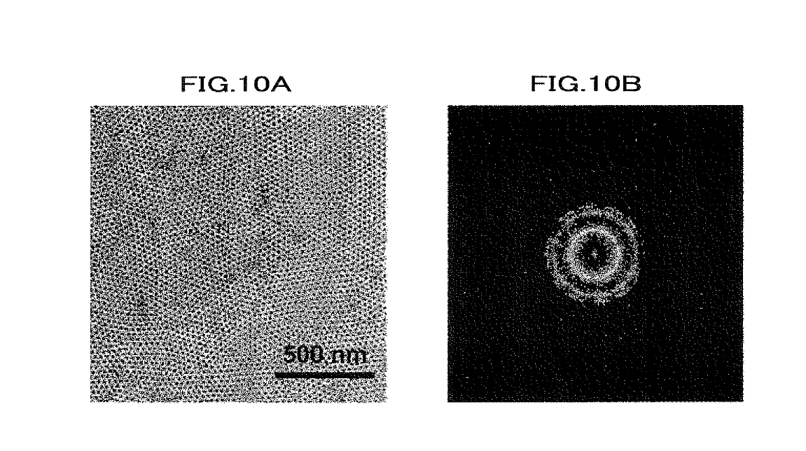

FIG. 10A shows the representative SEM image. Here, in many cases, cylindrical structures of PS-b-PMMA were arranged hexagonally in a local region standing upright on the surface of the substrate. Based on the SEM image of the structure (FIG. 10A), the intrinsic periodicity “d₀” was determined. That is, “d₀” was determined by performing the two dimensional Fourier transform of the SEM image using a general graphic software. As shown in FIG. 10B, the two dimensional Fourier transform image of the cylindrical structures arranged on the surface of the silicon substrate provided hollow patterns in which many spots were gathered. Therefore, “d₀” was determined based on the first hallow radius.

Here, the intrinsic periodicity “d₀” determined for each PS-b-PMMA is summarized in Table 1 as shown hereinafter.

(Chemical Registration)

A film of PS-b-PMMA was deposited on the surface of the chemically patterned substrate to form microdomains. When the lattice distance “d” was 24 nm or 48 nm, PS (36k)-b-PMMA (12k) was used as PS-b-PMMA in which a number average molecular weight (Mn) of the PS chain was 35,500 and Mn of the PMMA chain was 12,200 to form the films having different thicknesses. Further, when the lattice distance “d” was 32 nm or 64 nm, PS (46k)-b-PMMA (21k) was used as PS-b-PMMA in which a number average molecular weight (Mn) of the PS chain was 46,100 and Mn of the PMMA chain was 21,000 to form the films having different thicknesses. The deposition procedure was the same as mentioned previously. The obtained pattern shape in the film of PS-b-PMMA was analyzed by a scanning electron microscopy (SEM).

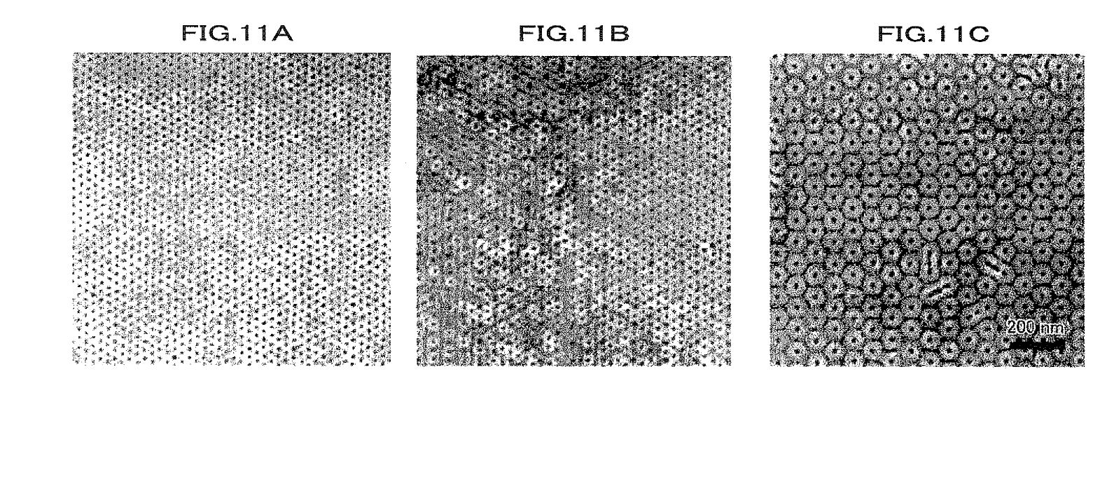

FIGS. 11A to 11C show the representative SEM images. FIG. 11A shows an SEM image, in which cylindrical structures were complemented between the chemical patterns through self-organization of PS (36k)-b-PMMA on the substrate chemically patterned with “d” of 48 nm. Each of cylindrical microdomains made of PMMA formed from PS-b-PMMA had a selective wettability to a silicon wafer exposed region on the surface of the chemically patterned substrate. This allowed the position of each cylindrical microdomain to be restricted. Further, a continuous phase made of PS formed from PS-b-PMMA had a selective wettability to a polystyrene grafted surface on the surface of the patterned substrate. This allowed the position of the continuous phase to be restricted. Moreover, the film thickness of PS-b-PMMA between the chemical patterns was controlled to thereby arrange the cylindrical microdomains standing upright on the substrate. Accordingly, the arrangement of the cylindrical microdomains disposed between the chemical patterns was restricted by the microdomains which were regularly disposed on the neighboring regions in which the silicon wafer was disposed, resulting in forming a periodic arrangement thereof in a long distance. In contrast, FIG. 11B shows a representative pattern in which the chemical registration insufficiently complemented the chemical patterns. The SEM image in FIG. 11B shows a structure generally observed when the thickness of the polymer film is close to the intrinsic periodicity “d₀”. Here, a portion of the patterns were complemented similarly to FIG. 11A, while in the SEM image of FIG. 11B, many regions were observed in which the cylindrical microdomains were not disposed standing upright on the substrate at the regions where no silicon wafer was exposed, that is, the regions between the chemical patterns. Further, FIG. 11C shows an example in which the pattern complementation was not substantially observed through the self-organization of PS (36k)-b-PMMA (12k).

Next, experimental results of PS (36k)-b-PMMA (12k) and PS (46k)-b-PMMA (21k) are summarized in Tables 1 and 2, in which the substrates having a hexagonal pattern comprising different periodicities “d” and film thicknesses “t” in the chemical pattern are used. Table 1 shows the results of PS (36k)-b-PMMA (12k) and Table 2 shows the results of PS (46k)-b-PMMA (21k). In Tables 1 and 2, “good” means that the same pattern as shown in FIG. 11A was obtained, “poor” means that the complement of the pattern was only partially observed as shown in FIG. 11B, or that almost no complement of the pattern was observed as shown in FIG. 11C.

As shown in Tables 1 and 2, a good chemical registration was observed in the case of each film thickness, when the intrinsic periodicity “d₀” was equal to the chemical pattern periodicity “d” of the substrate. In this case, the regularly arranged structure formed from PS-b-PMMA had no defect to be periodically disposed in a long distance. In contrast, when the pattern periodicity “d” is two times of the intrinsic periodicity “d₀”, a good chemical registration was observed only in the case that the film thickness “t” satisfied the following relationship: 1.3×d₀<t<1.7×d₀.

Here, according to the results in Table 1, when “m” described previously becomes 6 or more, a rate of defects is increased to more than 5%, even though the pattern complement is observed. Accordingly, it is confirmed that “m” is preferably set as 5 or less.

In the above mentioned embodiment, the periodicity “d” of the chemical pattern on the substrate was set as two times of the intrinsic periodicity “d₀” of PS-b-PMMA. However, as mentioned above, it is shown that the cylindrical structures may be regularly arranged in the periodicity “d” through the self-organization by controlling the film thickness “t” of PMMA as defined in the present invention. The results show that not only a throughput in a direct writing process of the chemical patterns may be increased, but a higher density of the chemical patterns may be achieved through the self-organization. This may suggest that a limitation of the lithography technique using the current top-down method may be overcome, allowing more extremely microfine patterns to be uniformly produced.

TABLE 1

| Property of PS-b-PMMA | | | | | |
|---|---|---|---|---|---|
| | Intrinsic | | Chemical | Chemical | |
| | Periodicity | Film Thickness | Registration ¹⁾ | Registration ²⁾ | Defect Ratio ³⁾ |
| PS-b-PMMA | d₀ (nm) | t (nm) | (Periodicity = d₀) | (Periodicity = 2d₀) | (Periodicity = 2d₀) |
| PS(36k)-b-PMMA(12k) | 24 | 24 | good | poor | — |
| | | 26 | good | poor | — |
| | | 28 | good | poor | — |
| | | 29 | good | poor | — |
| | | 30 | good | poor | — |
| | | 31 | good | good | <1% |
| | | 32 | good | good | <1% |
| | | 34 | good | good | <1% |
| | | 36 | good | good | <1% |
| | | 38 | good | good | <1% |
| | | 39 | good | good | <1% |
| | | 40 | good | good | — |
| | | 41 | good | poor | — |
| | | 42 | good | poor | — |
| | | 43 | good | poor | — |
| | | 44 | good | poor | — |
| | | 46 | good | poor | — |
| | | 48 | good | poor | — |
| | | 50 | good | poor | — |
| | | 52 | good | poor | — |
| | | 54 | good | poor | — |
| | | 55 | good | good | <1% |
| | | 56 | good | good | <1% |
| | | 58 | good | good | <1% |
| | | 60 | good | good | <1% |
| | | 84 | good | good | 1% |
| | | 108 | good | good | 1.2% |
| | | 132 | good | good | 1.9% |
| | | 156 | good | good | 7.4% |

¹⁾ State of the chemical registration when the periodicity of the pattern on the substrate is d₀.
²⁾ State of the chemical registration when the periodicity of the pattern on the substrate is 2d₀.
³⁾ Defect ratio f the patern when the state of the chemical registration is good with the pattern periodicity of 2d₀.

TABLE 2

| Property of PS-b-PMMA | | | | | |
|---|---|---|---|---|---|
| | Intrinsic | | Chemical | Chemical | |
| | Periodicity | Film Thickness | Registration ¹⁾ | Registration ²⁾ | Defect Ratio ³⁾ |
| PS-b-PMMA | d₀ (nm) | t (nm) | (Periodicity = d₀) | (Periodicity = 2d₀) | (Periodicity = 2d₀) |
| PS(46k)-b-PMMA(21k) | 32 | 32 | good | poor | — |
| | | 34 | good | poor | — |
| | | 36 | good | poor | — |
| | | 38 | good | poor | — |
| | | 40 | good | poor | — |
| | | 41 | good | poor | — |
| | | 42 | good | good | <1% |
| | | 43 | good | good | <1% |
| | | 44 | good | good | <1% |
| | | 46 | good | good | <1% |
| | | 48 | good | good | <1% |
| | | 50 | good | good | <1% |
| | | 52 | good | good | — |
| | | 53 | good | good | — |
| | | 54 | good | good | — |
| | | 55 | good | poor | — |
| | | 56 | good | poor | — |
| | | 58 | good | poor | — |
| | | 60 | good | poor | — |
| | | 62 | good | poor | — |
| | | 64 | good | poor | — |
| | | 66 | good | poor | — |
| | | 70 | good | poor | — |
| | | 72 | good | poor | — |
| | | 74 | good | good | <1% |
| | | 76 | good | good | <1% |
| | | 78 | good | good | <1% |
| | | 80 | good | good | <1% |
| | | 112 | good | good | 1% |
| | | 144 | good | good | 1.4% |
| | | 172 | good | good | 2.1% |
| | | 206 | good | good | 8.9% |

¹⁾ State of the chemical registration when the periodicity of the pattern on the substrate is d₀.
²⁾ State of the chemical registration when the periodicity of the pattern on the substrate is 2d₀.
³⁾ Defect ratio of the pattern when the state of the chemical registration is good with the pattern periodicity of 2d₀.

### Example 2

In this example, is described a process for producing a polymer film comprising a first microstructure of the present invention. More specifically, results of the experiments conducted by using PS-b-PMMA as a block copolymer forming a lamellar microdomain structure will be described in detail referring to Comparative Examples.

(Preparation of Chemically Patterned Substrate)

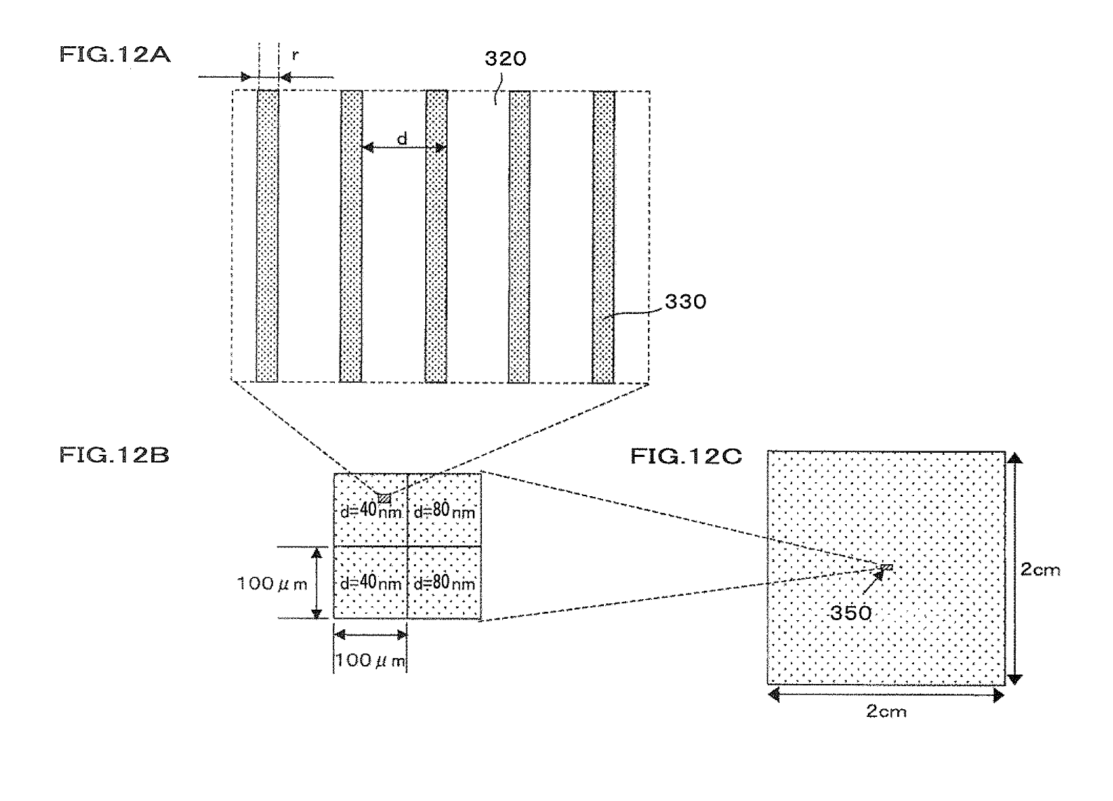

FIGS. 12A to 12C are schematic diagrams each showing a pattern arrangement of a chemically patterned substrate. Similarly to the process of Example 1, a polystyrene grafted layer disposed on a surface of a polystyrene grafted substrate 320 was patterned by the EB lithography method, to thereby produce a chemically patterned substrate. On the surface of the chemically patterned substrate, stripe shaped regions 330 with a width “r”, where a silicon wafer was exposed in the surface of the polystyrene grafted layer, were arranged parallelly in a lattice distance “d”. FIG. 12A shows the pattern arrangement prepared on the substrate. Here, regions (each with 100 μm×100 μm) with the stripe shaped patterns having a lattice distance “d” of 40 nm or 80 nm were continuously arranged on a plate of the substrate, which was cut out from a patterned region 350 (2 cm×2 cm). A width “r” was set to have a 25%-30% length of the lattice distance “d”.

(Chemical Registration)

A film of PS-b-PMMA was deposited on a surface of the chemically patterned substrate to form microdomains. In this embodiment, PS (52k)-b-PMMA (52k) was used as PS-b-PMMA in which a number average molecular weight (Mn) of the PS chain was 52,000 and Mn of the PMMA chain was 52,000 to form the films having different thicknesses “t”. The obtained pattern shape in the film of PS-b-PMMA was analyzed by a scanning electron microscopy (SEM). Separately, similarly to the process of Example 1, the intrinsic periodicity “d₀” was determined to give a 40 nm periodicity (d₀).

Next, as shown in Table 3, experimental results of PS (52k)-b-PMMA (52k) are summarized in which the substrates having a stripe shaped pattern comprising different periodicities “d” and film thicknesses “t” in the chemical pattern are used. In the results shown in Table 3, a good chemical registration was observed in the case of each film thickness, when the intrinsic periodicity “d₀” was equal to the chemical pattern periodicity “d” of the substrate. In this case, the regularly arranged structure formed from PS-b-PMMA had no defect to be periodically disposed in a long distance. In contrast, when the chemical pattern periodicity “d” was two times of the intrinsic periodicity “d₀”, a good chemical registration was observed only in the case that the respective film thicknesses “t” satisfied the following relationship: 0.3×d₀<t<0.7×d₀ or 1.3×d₀<t<1.7×d₀.

In the above mentioned embodiment, the periodicity “d” of the chemically patterned substrate was set as two times of the intrinsic periodicity “d₀” of PS-b-PMMA. However, as mentioned above, it is shown that the lamellar structures may be regularly arranged in the periodicity “d” of the chemical pattern through the self-organization by controlling the film thickness “t” of PS-b-PMMA as defined in the present invention. The results show that not only a throughput in a direct writing process of the chemical patterns may be increased, but a higher density of the chemical patterns may be achieved through the self-organization. This may suggest that a limitation of the lithography technique using the current top-down method may be overcome, allowing more extremely microfine patterns to be uniformly produced.

TABLE 3

| Property of PS-b-PMMA | | | | | |
|---|---|---|---|---|---|
| | Intrinsic | | Chemical | Chemical | |
| | Periodicity | Film Thickness | Registration ¹⁾ | Registration ²⁾ | Defect Ratio ³⁾ |
| PS-b-PMMA | d₀ (nm) | t (nm) | (Periodicity = d₀) | (Periodicity = 2d₀) | (Periodicity = 2d₀) |
| PS(52k)-b-PMMA(52k) | 40 | 24 | good | good | — |
| | | 26 | good | good | — |
| | | 28 | good | good | — |
| | | 30 | good | poor | — |
| | | 32 | good | poor | <1% |
| | | 34 | good | poor | <1% |
| | | 36 | good | poor | <1% |
| | | 38 | good | poor | <1% |
| | | 40 | good | poor | — |
| | | 42 | good | poor | — |
| | | 44 | good | poor | — |
| | | 46 | good | poor | — |
| | | 48 | good | poor | — |
| | | 50 | good | poor | — |
| | | 52 | good | good | <7% |
| | | 54 | good | gppd | <1% |
| | | 56 | good | good | <1% |
| | | 58 | good | good | <1% |
| | | 60 | good | good | <1% |
| | | 62 | good | good | <1% |
| | | 64 | good | good | <1% |
| | | 66 | good | good | <1% |
| | | 68 | good | good | <5% |
| | | 70 | good | poor | — |
| | | 72 | good | poor | — |
| | | 74 | good | poor | — |

¹⁾ State of the chemical registration when the periodicity of the pattern on the substrate is d₀.
²⁾ State of the chemical registration when the periodicity of the pattern on the substrate is 2d₀.
³⁾ Defect ratio of thepattern when the state of the chemical registration is good with the pattern periodicity of 2d₀.

### Example 3

In this example, is described a process for producing a polymer film comprising a first microstructure of the present invention. More specifically, results of the experiments conducted by using PS-b-polydimethylsiloxane (PDMS) as a block copolymer will be described in detail referring to Comparative Examples.

(Preparation of Chemically Patterned Substrate)

A polystyrene grafted substrate was prepared in the similar process to Example 1 and a surface of the polystyrene grafted substrate was analyzed. As a result, it was confirmed that a polystyrene grafted film was deposited on the surface of the silicon wafer.

Similarly to the process of Example 1, a polystyrene grafted layer on a surface of a polystyrene grafted substrate 320 was patterned by the EB lithography method, to thereby produce a chemically patterned substrate. On the surface of the substrate, circle regions 330 with a diameter “r”, in which a silicon wafer was exposed on the surface of the polystyrene grafted layer, were arranged hexagonally with a lattice distance “d”. FIGS. 9A to 9C show the pattern arrangement prepared on the substrate. Here, the regions (each with 100 μm×100 μm) with hexagonal patterns having a lattice distance “d” of 14 nm were continuously arranged on a plate of the substrate. The diameter “r” was set to be about 25-30% of the lattice distance “d”.

(Measurement of Intrinsic Periodicity “d₀”)

The intrinsic periodicity “d₀” of each block copolymer (PS-b-PDMS) was determined by the following procedure. First, a sample of PS-b-PDMS was solved in toluene of a semiconductor grade to prepare a PS-b-PDMS solution at the predetermined concentration of 1.0 wt %. Then, the PS-b-PDMS solution was spread on the surface of the silicon substrate by a spin coater so that a thickness of PS-b-PDMS was to be 25 nm. Then, the substrate was annealed at 170° C. for 24 hr in a vacuum oven undergoing the microphase separation process, thereby to form a self-assembled structure in the equilibrium state.

The microdomains in the film of PS-b-PDMS deposited on the substrate surface were analyzed by a scanning electron microscope (SEM).

The SEM analysis was performed by S4800 (Hitachi, Ltd.) at an acceleration voltage of 0.7 kv. The samples of the SEM analysis were prepared as follows. First, PS microdomains in the film of PS-b-PDMS were decomposed and removed by the RIE method, thereby to produce a polymer film comprising nano scale protrusion/indentation shapes derived from the microdomains. In the RIE method, RIE-10NP (SUMCO Inc.) was used under the following conditions: CF₄ gas pressure: 1.0 Pa, gas flow rate: 10 cm³/min, power: 50 w, etching time: 5 sec, and then oxygen gas pressure: 1.0 Pa, gas flow rate: 10 cm³/min, power: 100 w, etching time: 20 sec. Herein, deposition of Pt on the sample surface generally performed for an antistatic treatment in the SEM analysis was not conducted so as to accurately determine the microstructure. Necessary contrast was achieved by controlling the acceleration voltage.

Here, the intrinsic periodicity “d₀” was determined similarly to Example 1, giving a value of “d₀” as 14 nm.

(Chemical Registration)

A film of PS-b-PDMS was deposited on a surface of the chemically patterned substrate to form microdomains. In this embodiment, PS (8.5 k)-b-PDMS (4.5 k) was used as PS-b-PDMS in which a number average molecular weight (Mn) of the PS chain was 8,500 and Mn of the PDMS chain was 4,500 to form the films having different thicknesses “t”. The obtained pattern shape in the film of PS-b-PDMS was analyzed by a scanning electron microscopy (SEM).

As a result, each of PDMS cylinders formed from PS-b-PDMS had a selective wettability to the PDMS grafted layer on the surface of the chemically patterned substrate to restrict the position of the PDMS cylinder. Further, a PS continuous phase formed from PS-b-PDMS had a selective wettability to a silicon substrate surface on the surface of the patterned substrate. Herein, PS-b-PDMS was controlled by the film thickness “t” at the region between the chemical patterns, resulting in the arrangement of the columnar cylinders standing upright on the substrate. Accordingly, the arrangement of the columnar cylinders at the region between the chemical patterns was restricted by other columnar cylinders which were regularly arranged on the neighboring regions where the silicon wafer was exposed. Accordingly, it is observed that the columnar cylinders are periodically arranged in a long distance.

As shown in Table 4, experimental results of PS (8.5 k)-b-PDMS (4.5 k) are summarized in which the substrates having a hexagonal pattern comprising different periodicities “d” and film thicknesses “t” in the chemical pattern are used. In Table 4, “good” means that the same pattern as shown in FIG. 11A was obtained, “poor” means that the complement of the pattern was only partially observed as shown in FIG. 11B, or that almost no complement of the pattern was observed as shown in FIG. 11C indicating the state that columnar cylinders at the region between the patterns lay down on the substrate.

As shown in Table 4, when the intrinsic periodicity “d₀” was equal to the pattern periodicity “d”, a good chemical registration was observed in the case of each thickness “t” so that the regularly arranged structure formed from PS-b-PDMS had no defect to be periodically disposed in a long distance. In contrast, when the chemical pattern periodicity “d” of the substrate was two times of the intrinsic periodicity “d₀”, a good chemical registration was observed only when the film thickness “t” satisfied the following relationship: 1.3×d₀<t<1.7×d₀.

In the above mentioned embodiment, the periodicity “d” of the chemically patterned substrate was set as two times of the intrinsic periodicity “d₀” of PS-b-PDMS. However, as mentioned above, it is shown that the cylindrical structures may be regularly arranged in the periodicity “d” through the self-organization by controlling the film thickness “t” of PS-b-PDMS as defined in the present invention. The results show that not only a throughput in a direct writing process of the chemical patterns may be increased, but a higher density of the chemical patterns may be achieved through the self-organization. This may suggest that a limitation of the lithography technique using the current top-down method may be overcome, allowing more extremely microfine patterns to be uniformly produced.

TABLE 4

| Property of PS-b-PDMS | | | | | |
|---|---|---|---|---|---|
| | Intrinsic | | Chemical | Chemical | |
| | Periodicity | Film Thickness | Registration ¹⁾ | Registration ²⁾ | Defect Ratio ³⁾ |
| PS-b-PDMS | d₀ (nm) | t (nm) | (Periodicity = d₀) | (Periodicity = 2d₀) | (Periodicity = 2d₀) |
| PS(8.5k)-b-PDMS(4.5k) | 14 | 13 | good | poor | — |
| | | 14 | good | poor | — |
| | | 15 | good | poor | — |
| | | 16 | good | poor | — |
| | | 17 | good | poor | — |
| | | 18 | good | poor | <1% |
| | | 19 | good | good | <1% |
| | | 20 | good | good | <1% |
| | | 21 | good | good | <1% |
| | | 22 | good | good | <1% |
| | | 23 | good | good | <1% |
| | | 24 | good | good | <1% |
| | | 25 | good | good | — |
| | | 26 | good | good | — |
| | | 27 | good | good | — |
| | | 28 | good | poor | — |
| | | 30 | good | poor | — |
| | | 31 | good | poor | — |
| | | 32 | good | poor | <1% |
| | | 33 | good | poor | <1% |
| | | 34 | good | poor | <1% |
| | | 35 | good | poor | <1% |
| | | 49 | good | poor | <1% |
| | | 63 | good | poor | <1% |
| | | 77 | good | good | 1.1% |
| | | 91 | good | good | 3.7% |

¹⁾ State of the chemical registration when the periodicity of the pattern on the substrate is d₀.
²⁾ State of the chemical registration when the periodicity of the pattern on the substrate is 2d₀.
³⁾ Defect ratio of the pattern when the state of the chemical registration is good with the pattern periodicity of 2d₀.

### Example 4

Next, an exemplified process for producing a patterned substrate will be described hereinafter. In an embodiment, first, in the steps shown in FIGS. 8A and 8B, a cylindrical phase D in a polymer film C was decomposed and removed to form a porous film D on the surface of the substrate 20.

Following the process in Example 1, a polymer film having a structure in which cylindrical phases B comprising PMMA were disposed standing upright on the film surface (that is, in a penetrating direction of the polymer film C) was prepared on the surface of the substrate 20. Herein, the chemical pattern was arranged as shown in FIG. 9A similarly to Example 1. Further, a high-molecular block copolymer composition comprising PS-b-PMMA as a main component was used similarly to Example 1, in which a number average molecular weight (Mn) of the PS chain was 35,500, a number average molecular weight (Mn) of the PMMA chain was 12,200, and a molecular weight distribution (Mw/Mn) was 1.04.

A solution of PS-b-PMMA was spread on a surface of the substrate which was chemically patterned with a periodicity two times of the intrinsic periodicity “d₀” of PS (36k)-b-PMMA (12k) so that the film thickness was to be 36 nm. Then, the substrate was thermally annealed to undergo the microphase separation, to thereby produce a structure in which the cylindrical phases B comprising polymethyl methacrylate (PMMA) were regularly arranged in the continuous phase A comprising polystyrene (PS). Then, the cylindrical phases B were removed by RIE to produce a porous film D under the following conditions: oxygen gas pressure: 1 Pa; power: 20 w, and etching time: 90 sec.

The surface of the porous film D thus produced was analyzed by a scanning electron microscope (SEM).

As a result, it was determined that micropores H with a cylindrical shape were formed in a penetration direction of the polymer film C on the entire surface of the porous film D. A diameter of the micropore H was about 15 nm. Further, an arrangement of the micropores H in the porous film D thus obtained was analyzed in detail. Accordingly, it was observed that the micropores H were hexagonally arranged in a single direction without any defect in a region where the surface thereon was chemically patterned with a periodicity “d” of 24 nm. In contrast, in a region where the surface thereon was not chemically patterned, the micropores H were arranged hexagonally microscopically, while a grain was macroscopically formed by the regions where the micropores H were arranged hexagonally. In this case, many lattice defects were observed particularly at the interfacial region of the grain.

Next, a part of the porous film D with the whole width was peeled off from the surface of the substrate 20 using a sharp-edged tool to analyze a distance between the surface of the substrate 20 and the upper surface of the porous film D by an atomic force microscope (AFM). As a result, the distance was about 30 nm.

Here, an aspect ratio of the micropore H thus obtained was 2.0. Note this is a large value which may not be achieved in a spherical microdomain structure. Herein, it was observed that the thickness of the polymer film C was 36 nm before the RIE procedure, while the thickness was decreased to be 30 nm after the RIE procedure. This decrease of the thickness may be caused because the continuous phase A comprising polystyrene (PS) was partially etched as well as the cylindrical phase B comprising polymethyl methacrylate (PMMA) during the RIE procedure.

Next, the substrate 20 made of silicon was etched using the porous film D as a mask, to thereby transfer the pattern of the porous film D onto the substrate. In this etching process, dry etching was performed using CF₄ gas. As a result, the shape and arrangement of the micropore H in the porous film D were successfully transferred onto the silicon substrate.

### EXPLANATION OF THE LETTERS AND NUMERALS

101 first segment
102 second segment
103 high-molecular weight block copolymer
104 cylindrical microdomain
105 chemically pattern substrate
106 first surface
107 second surface
201 substrate
202 polymer film
203 cylindrical microdomain
204 continuous phase
205 microfine structure
206 microhole
207 molecular thin layer
208 cylindrical microdomain
301 reference sign do
401 chemically modified layer
402 resist layer
403 exposure
404 development process
405 etching
406 chemically pattern substrate
407 resist removing
501 chemically modified layer
502 chemically modified layer

What is claimed is:

1. A process for producing a microfine structure comprising:
a first stage of disposing a polymer layer comprising a block copolymer having at least a first segment and a second segment on a surface of a substrate; and
a second stage of having the polymer layer undergo microphase separation and form a structure composed of a continuous phase made of the second segments and microdomains which are made of the first segments and are arranged in a penetration direction of the continuous phase, wherein
the substrate has pattern members, each of the pattern members being sparsely disposed at a position where the microdomain is to be formed and different in chemical property from the surface of the substrate, and
a thickness “t” of the polymer layer disposed in the first stage and an intrinsic periodicity “d₀” of the microdomains formed from the block copolymer satisfy the relationship:
(m+0.3)×d₀<t<(m+0.7)×d₀, where m is an integer of 0 or more.

2. The process for producing the microfine structure described in claim 1, wherein
the surface of the substrate comprises a first surface which is sparsely disposed on a second surface,
interfacial tension with the first surface of a first material constituting the first segment is smaller than interfacial tension with the first surface of a second material constituting the second segment, and
interfacial tension with the second surface of the second material constituting the second segment is smaller than interfacial tension with the second surface of the first material constituting the first segment.

3. The process for producing the microfine structure described in claim 1, wherein
a ratio of densities between the microdomains and the pattern members is n: 1, where n is a positive number of 2 or more.

4. The process for producing the microfine structure described in claim 3, wherein the pattern members sparsely disposed are regularly arranged.

5. The process for producing the microfine structure described in claim 1, wherein each of the microdomains is formed having a cylindrical structure.

6. The process for producing the microfine structure described in claim 1, wherein each of the microdomains is formed having a lamellar structure.

7. The process for producing the microfine structure described in claim 1, wherein the pattern members are regularly arranged on the surface of the substrate, and an average periodicity “d” of the pattern member is a multiple of the natural number of the intrinsic periodicity “d₀” of the microdomain.

8. A microfine structure manufactured by the process for producing the microfine structure described in claim 1.

9. A process for producing a patterned substrate comprising:
a first stage of disposing a polymer layer comprising a block copolymer having at least a first segment and a second segment on a surface of a substrate;
a second stage of having the polymer layer undergo microphase separation and form a structure composed of a continuous phase made of the second segments and microdomains which are made of the first segments and are arranged in a penetration direction of the continuous phase; and
a third stage of selectively removing either of the continuous phase or the microdomains, wherein
the substrate has pattern members, each of the pattern members being sparsely disposed at a position where the microdomain is to be formed and different in chemical property from the surface of the substrate, and
a thickness “t” of the polymer layer disposed in the first stage and an intrinsic periodicity “d₀” of the microdomains formed from the block copolymer satisfy the relationship:
(m+0.3)×d₀<t<(m+0.7)×d₀, where m is an integer of 0 or more.

10. The process for producing the patterned substrate described in claim 9, further comprising a step of etching the substrate by using the continuous phase or the microdomains remained after the third stage as a mask.

11. A patterned substrate manufactured by the process for producing the patterned substrate described in claim 9.

12. A patterned substrate manufactured by the process for producing the patterned substrate described in claim 10.

13. A patterned substrate replicated by transferring the pattern arrangement of the patterned substrate described in claim 12, wherein the patterned substrate of claim 12 is used as a master.
